(19) United States
(12) Patent Application Publication
(10) Pub. No.: US 2026/0231179 A1
(43) Pub. Date: Aug. 6, 2026

(54) METHOD AND APPARATUS FOR MEASUREMENT GAP CANCELLATION IN WIRELESS COMMUNICATION SYSTEM

(71) Applicant: SETLAB Co., LTD., Gyeonggi-do (KR)

(72) Inventor: Soenghun KIM, Gyeonggi-do (KR)

(21) Appl. No.: 19/531,684

(22) Filed: Feb. 6, 2026

(30) Foreign Application Priority Data
Feb. 6, 2025 (KR) 10-2025-0015492
Jan. 25, 2026 (KR) 10-2026-0014545

(51) Int. Cl. H04W 72/232; H04L 43/0817

(52) U.S. Cl. CPC H04W 72/232; H04L 43/0817

(57) ABSTRACT

A method and apparatus for measurement gap (MG) cancellation in wireless communication are provided. A user equipment (UE) receives a Radio Resource Control (RRC) message including MG cancellation information for specific Downlink Control Information (DCI) formats and MG configuration. Upon receiving a DCI format indicating MG cancellation, the UE cancels a specific MG based on the Frequency Range (FR) of an associated serving cell. This enables dynamic cancellation of per-FR1 or per-FR2 measurement gaps for flexible resource management based on scheduling decisions.

### CROSS-REFERENCE TO RELATED APPLICATION

This application claims priority to and the benefit of Korean Patent Application Nos. 10-2025-0015492, filed on Feb. 6, 2025, and 10-2026-0014545, filed on Jan. 25, 2026. Each of the above documents is incorporated herein by reference in its entirety.

### BACKGROUND

### Technical Field

The present disclosure relates to a method and apparatus for cancelling measurement gaps based on frequency range information in a wireless communication system.

### Related Art

To meet the increasing demand for wireless data traffic since the commercialization of 4th generation (4G) communication systems, the 5th generation (5G) system is being developed. For the sake of high, 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

Extended Reality (XR) refers to all real-and-virtual combined environments and human-machine interactions generated by computer technology and wearables. XR is an umbrella term for different types of realities.

During a XR service, huge amount of Data Bursts may be generated and transmitted over NR downlink and uplink. Data Burst of XR services often have stringent delay budget. It requires more sophisticated scheduling technique to achieve timely scheduling and to avoid excessive resource waste.

### SUMMARY

This disclosure relates to a method and apparatus for measurement gap (MG) cancellation in a wireless communication system, enabling flexible and efficient resource management based on dynamic scheduling decisions.

A user equipment (UE) receives a Radio Resource Control (RRC) message from a base station containing two key pieces of information: first, information indicating whether MG cancellation related information is included for a specific set of Downlink Control Information (DCI) formats, and second, MG configuration information that configures per-Frequency Range 1 (FR1) gap and per-Frequency Range 2 (FR2) gap. The specific set of DCI formats includes at least two DCI formats for uplink scheduling and two DCI formats for downlink scheduling.

When the UE receives a specific DCI format with MG cancellation related information set to a specific value, it cancels a specific MG determined based on the Frequency Range (FR) to which a serving cell associated with the received DCI format belongs. If the serving cell is on FR1, a per-FR1 gap is cancelled; if on FR2, a per-FR2 gap is cancelled. The cancelled MG is at least one MG occurring after a certain time point determined by the DCI reception time and a predefined time offset.

Importantly, MG cancellation is not applied to certain gaps including positioning measurement gaps and pre-configured measurement gaps. For activated and non-cancelled MGs, the UE performs specific operations such as not transmitting HARQ feedback, SR, CSI, and SRS, while maintaining essential functions like Msg3 transmission and PDCCH monitoring when random access response is expected.

### BRIEF DESCRIPTION OF THE DRAWINGS

FIG. 1 is a diagram illustrating the architecture of an 5G system and a NG-RAN;

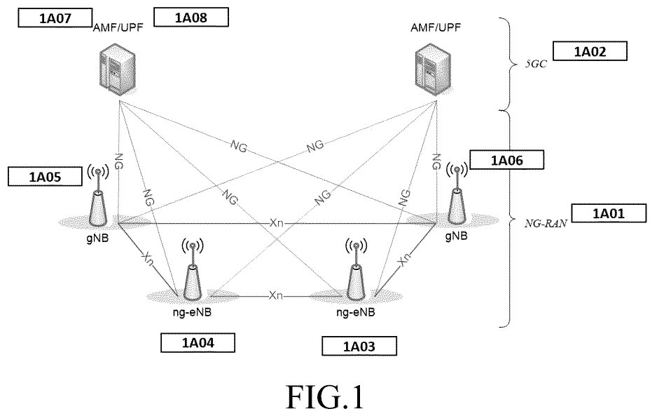

FIG. 2 is a diagram illustrating a wireless protocol architecture in an 5G system;

FIG. 3 illustrates overall operation of the UE and network.

FIG. 4 illustrates the operation of the UE regarding PLMN selection and cell selection and cell reselection.

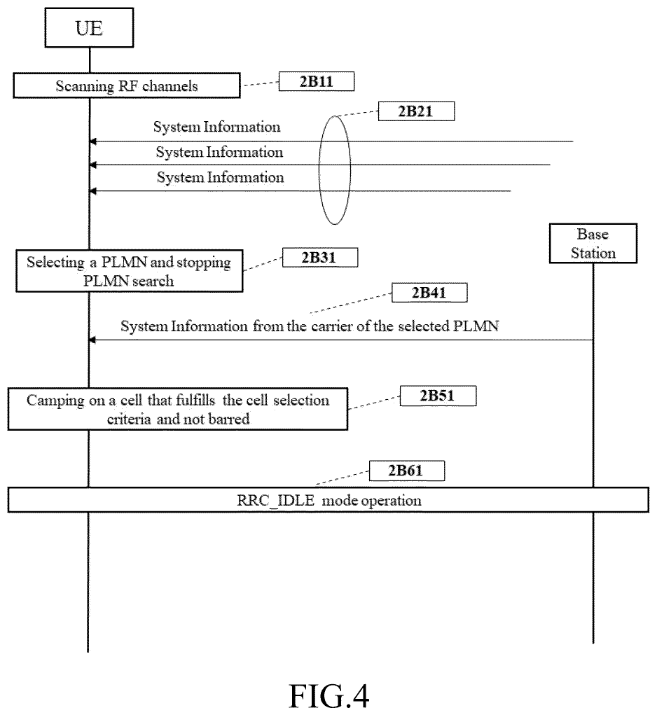

FIG. 5 illustrates RRC connection establishment procedure.

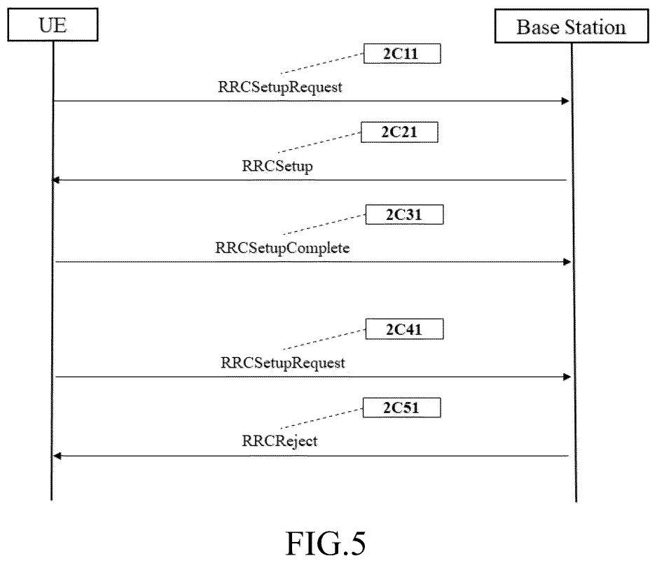

FIG. 6 illustrates UE capability transfer procedure.

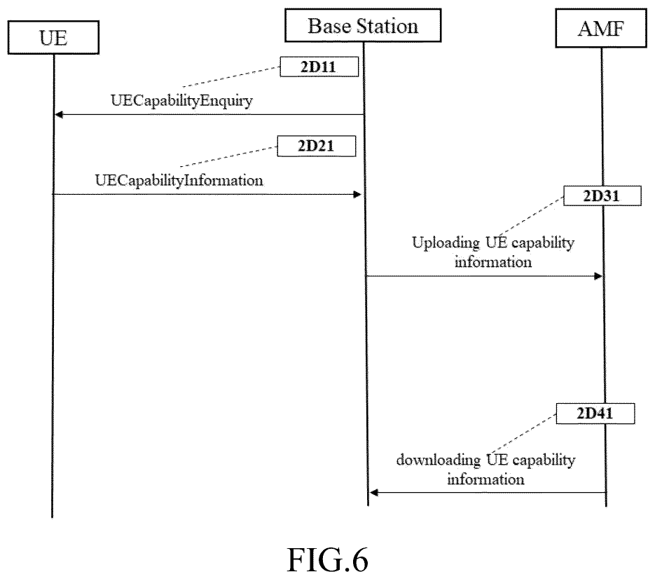

FIG. 7 illustrates RRC connection reconfiguration procedure.

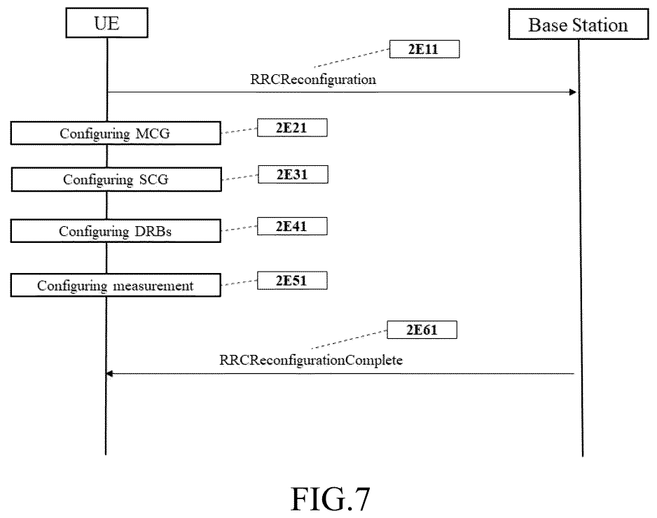

FIG. 8 illustrates data transfer procedure in RRC_CONNECTED state.

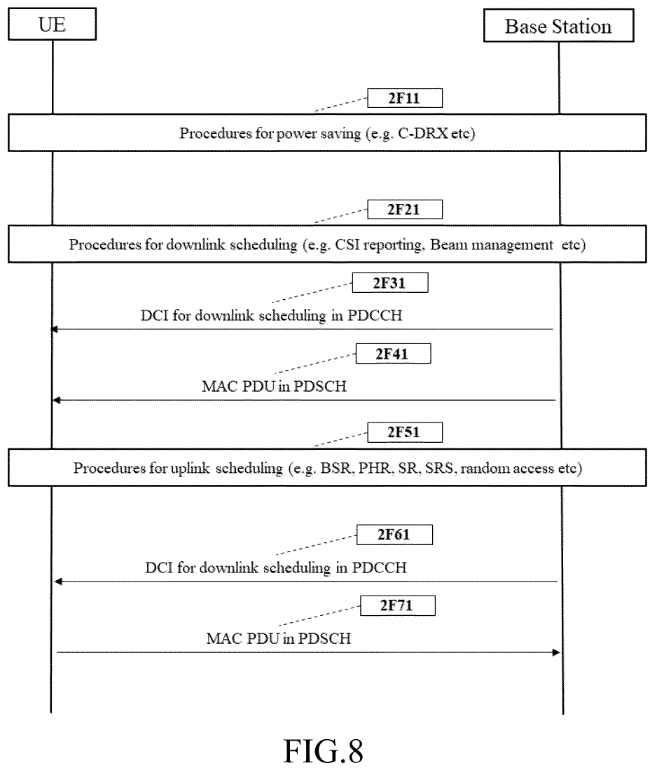

FIG. 9 illustrates operations of UE and base station.

FIG. 10 is a diagram illustrating operations of the terminal.

FIG. 11 is a diagram illustrating operations of the base station.

FIG. 12 is a block diagram illustrating a user equipment.

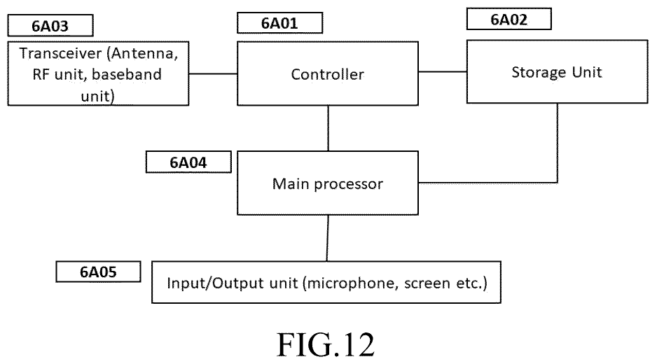

FIG. 13 is a block diagram illustrating a base station.

### DETAILED DESCRIPTION

In the rapidly evolving landscape of wireless communication, Extended Reality (XR) applications, encompassing Augmented Reality (AR), Virtual Reality (VR), and Mixed Reality (MR), demand superior data handling capabilities to deliver seamless user experiences. The Buffer Status Reporting (BSR) mechanism in the MAC layer plays a pivotal role in ensuring efficient data transmission by reporting the status of buffers at the user equipment (UE) to the network. However, the traditional BSR mechanisms face challenges in meeting the low latency requirements critical for XR applications.

The present disclosure focuses on mitigating latency issues and ensuring robust connectivity, thereby enabling a seamless and responsive XR experience based on a new mechanism to report delay sensitive data to the base station. This solution aims to enhance data throughput, reduce latency, and improve overall network performance, thereby providing a more immersive and responsive XR experience.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.
NAS: authentication, mobility management, security control etc
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

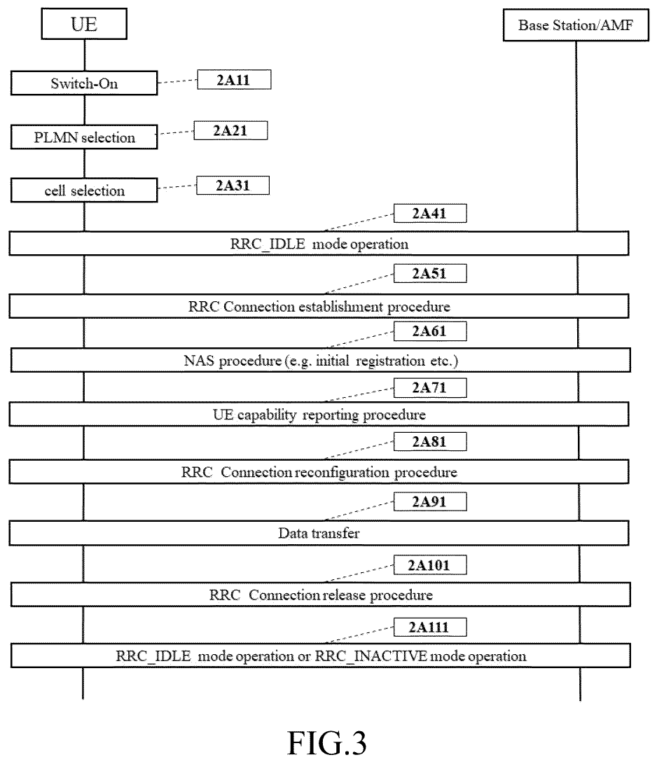

FIG. 3 illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE perform RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

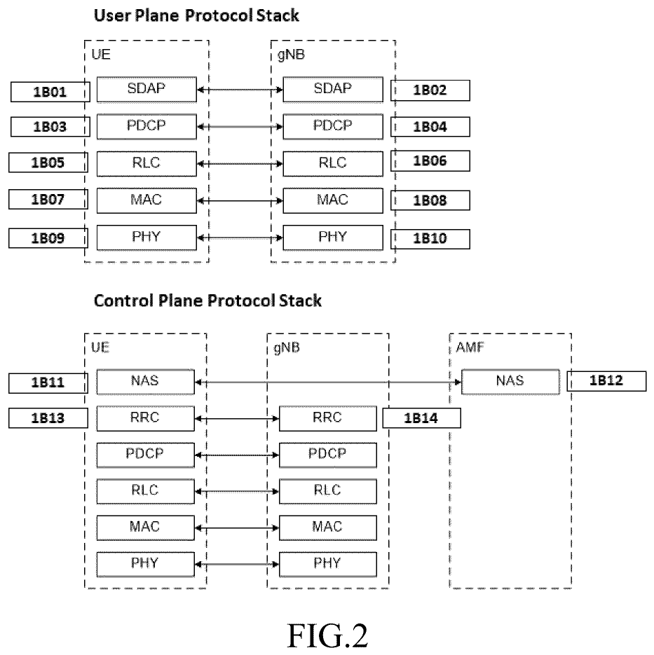

FIG. 2B illustrates the operation of the UE regarding PLMN selection and cell selection and cell reselection.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE considers cell selection criterion S is fulfilled when:
Srxlev>0 AND Squal>0
where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE perform RRC_IDLE mode operation 2B61 such as monitoring control channels to receive system information and paging and notification message.

FIG. 2C illustrates RRC connection establishment procedure.

Successful RRC connection establishment procedure includes:
>1: transmission of RRCSetupRequest by the UE 2C11;
>1: reception of RRCSetup by the UE 2C21;
>1: transmission of RRCSetupComplete by the UE 2C31.

Unsuccessful RRC connection establishment procedure includes:
>1: transmission of RRCSetupRequest by the UE 2C41;
>1: reception of RRCReject by the UE 2C51;

RRCSetupRequest includes following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup includes following fields and IEs:
>1: radioBearerConfig field containing a RadioBearerConfig IE;
>1: masterCellGroup field containing a CellGroupConfig IE.

RRCSetupComplete includes following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

For network to configure the UE with appropriate configurations, the network needs to know the capability of the UE. For this end, the UE and the base station perform UE capability transfer procedure.

UE capability transfer procedure consists of exchanging UECapabilityEnquiry 2D11 and UECapabilityInformation 2D21 between the UE and the base station.

In the UECapabiliityEnquiry, the base station indicates which RAT is subject to capability reporting. UE transmits the capability information for the requested RAT in the UECapabilityInformation.

Once UECapabilityInformation is received, the capability information is uploaded to the AMF by the base station 2D31. When UE capability information is needed afterward, AMF provide it to the base station 2D41.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2E11 and RRCReconfigurationComplete 2E61 between the base station and the UE.

RRCReconfiguration may include following fields and IEs:
>1: rrc-TransactionIdentifier field contains a RRC-TransactionIdentifier IE;
>1: radioBearerConfig field contains a RadioBearerConfig IE;
>>2: radioBearerConfig field includes configuration information for SRBs and DRBs via which RRC messages and user traffic are transmitted and received;
>1: secondaryCellGroup field contains a CellGroupConfig IE;
>>2: secondaryCellGroup field includes configuration information for secondary cell group;
>>2: A cell group consists of a SpCell and zero or more SCells;
>>2: Cell group configuration information includes cell configuration information for SpCell/SCell and configuration information for MAC and configuration information for logical channel etc;
>1: measConfig field contains a MeasConfig IE;
>>2: measConfig field includes configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2E21;
>1: perform the cell group configuration for SCG based on the received secondaryCellGroup 2E31;
>1: perform the radio bearer configuration based on the received radioBearerConfig 2E41;
>1: perform the measurement configuration based on the received measConfig 2E51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

The UE and the base station may perform procedures for power saving such as C-DRX 2F11. The configuration information for C-DRX is provided to the UE within cell group configuration in the RRCReconfiguration.

The UE and the base station may perform various procedures for downlink scheduling 2F21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2F31. The base station transmits to the UE PDSCH corresponding to the DCI and containing a MAC PDU 2F41.

The UE and the base station may perform various procedure for uplink scheduling 2F51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2F61. The base station transmits to the UE PDSCH corresponding to the DCI and containing a MAC PDU 2F71.

RRC connection release procedure includes:
>1: transmission of RRCRelease from the base station to the UE 2G11; and
>1: transmission of acknowledgement for the RRCRelease from the UE to the base station 2G21; and
>1: state transition from RRC_CONNECTED to either RRC_IDLE or RRC_INACTIVE 2G31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities.

The RRCRelease may include following fields for redirection:
>1: redirectedCarrierInfo field includes RedirectedCarrierInfo IE;
>>2: RedirectedCarrierInfo IE includes either CarrierInfoNR IE or RedirectedCarrierInfo-EUTRA IE;
>>>3: CarrierInfoNR IE includes ARFCN-ValueNR IE and SubcarrierSpacing IE;

The UE may perform cell selection on the carrier indicated by CarrierInfoNR IE or RedirectedCarrierInfo-EUTRA IE.

The RRCRelease may include following fields to configure cell reselection priority:
>1: cellReselectionPriorities field includes CellReselectionPriorities IE;
>>2: CellReselectionPriorities IE includes:
>>>3: FreqPriorityListNR IE;
>>>3: t320 field indicates a timer value for cell reselection priority validity;

During idle mode mobility, the UE applies the CellReselectionPriorities until T320 expires or stops.

The RRCRelease may include following fields/IEs to transition UE to RRC_INACTIVE state:
>1: suspendConfig field includes SuspendConfig IE;
>>2: fullI-RNTI field includes I-RNTI-Value IE;
>>2: shortI-RNTI field includes ShortI-RNTI-Value IE;
>>2: ran-PagingCycle field includes PagingCycle IE;
>>2: ran-NotificationAreaInfofield includes RAN-NotificationAreaInfo IE;
>>2: t380 field includes PeriodicRNAU-Timer Value;
>>2: nextHopChainingCount field includes NextHopChainingCount IE.
>>2: ran-ExtendedPagingCycle field includes ExtendedPagingCycle IE.

To transit the UE to RRC_INACTIVE, the base station includes SuspendConfig IE in the RRCRelease. To transit the UE to RRC_IDLE, the base station does not include SuspendConfig IE in the RRCRelease.

Upon reception of RRCRelease, UE may:
>1: delay the actions caused by RRCRelease 60 ms from the moment the RRCRelease message was received or optionally when lower layers indicate that the receipt of the RRCRelease message has been successfully acknowledged, whichever is earlier;
>1: store the cell reselection priority information provided by the cellReselectionPriorities and start T320;
>1: if the RRCRelease includes suspendConfig:
>>2: reset MAC and release the default MAC Cell Group configuration;
>>2: apply the received suspendConfig except the received nextHopChainingCount;
>>2: if the sdt-Config is configured:
>>>3: for each of the DRB in the sdt-DRB-List, consider the DRB to be configured for SDT;
>>>3: if sdt-SRB2-Indication is configured, consider the SRB2 to be configured for SDT;
>>>3: re-establish the RLC entity for each RLC bearer that is not suspended;
>>>3: trigger the PDCP entity to perform SDU discard for SRB1 and SRB2;
>>>3: if sdt-MAC-PHY-CG-Config is configured, configure the PCell with the configured grant resources for SDT and start the cg-SDT-TimeAlignmentTimer;
>>3: if srs-PosRRC-Inactive is configured, apply the configuration and instruct MAC to start the inactivePosSRS-TimeAlignmentTimer;
>>2: re-establish RLC entities for SRB1;
>>2: stop the timer T319 if running;
>>2: store in the UE Inactive AS Context the nextHopChainingCount received in the RRCRelease message, the current KgNB and KRRCint keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within Reconfiguration WithSync of the NR PSCell (if configured) and all other parameters configured except for:
>>>3: parameters within ReconfigurationWithSync of the PCell;
>>>3: parameters within ReconfigurationWithSync of the NR PSCell, if configured;
>>>3: parameters within MobilityControlInfoSCG of the E-UTRA PSCell, if configured;
>>>3: servingCellConfigCommonSIB;
>>2: suspend all SRB(s) and DRB(s) and multicast MRB(s), except SRB0 and broadcast MRBs;
>>2: indicate PDCP suspend to lower layers of all DRBs and multicast MRBs;
>>2: start timer T380, with the timer value set to t380;
>>2: indicate the suspension of the RRC connection to upper layers;
>>2: enter RRC_INACTIVE and perform cell selection;
>1: else (if the RRCRelease does not include suspendConfig):
>>2: perform the actions upon going to RRC_IDLE;

RRC connection resume procedure, in case of state transition from RRC_INACTIVE to RRC_CONNECTED, consists of RRC message exchange between the UE and the base station: RRCResumeRequest 2H11 and RRCResume 2H21 and RRCResumeComplete 2H31.

RRC connection resume procedure, in case of small data transmission without state transition, consists of RRC message exchange between the UE and the base station: RRCResumeRequest 2H41 and RRCRelease 2H51.

RRC connection resume procedure is triggered by the UE due to various reasons. For example, RRC connection resume procedure for state transition is triggered periodically (upon T380 expiry) or event-driven (upon cell change to different RAN area) or data driven (upon uplink or downlink data arrival). RRC connection resume procedure for small data transmission is triggered only if channel condition is above specific threshold and the amount of data is expected to be relatively small.

Upon initiation of RRC connection resume procedure, the UE performs some preliminary operation such as starting timers such as T319 (for supervising the procedure) and timeAlignmentTimer (for uplink timing alignment) and applying common channel configuration (for transmission of RRCResumeRequest). Then UE transmits RRCResumeRequest 2H11 or 2H41 to the base station. The message includes the UE identifier which can be used by the base station to identify the UE context where RRC connection information of the UE is stored.

When the base station determines that UE needs to be in RRC_CONNECTED state, the base station transmits RRCResume. Upon reception of RRCResume 2H21, the UE restores whole UE context based on the stored context at the time of RRCRelease reception and the received information in the RRCResume.

If the RRC connection resume procedure is triggered for small data transmission, the UE and the base station may perform data transfer during RRC connection resume procedure 2H51. When the base station determines that small data transmission is finished, the base station transmits RRCRelease 2H61.

For efficient network operation and ensuring a seamless mobility, RRM measurement is essential. RRM measurement comprises intra-frequency measurement and inter-frequency measurement and inter-RAT measurement. One purpose of RRM measurement is to find suitable cells for mobility (e.g. the neighbouring cell of which reference channel is better than that of the serving cell etc). RRM measurement may be understood as measurement for mobility purpose that are configured by network/GNB to the terminal in RRC layer. RRM measurement is configured by a set of parameters for measurement called MeasConfig.

UE is required to perform intra-frequency measurement and inter-frequency measurement (if configured) and inter-RAT measurement (if configured) based on one of more sets of parameters for measurement objects (each set is called MeasObject). UE may trigger measurement reporting procedure based on one or more sets of parameters for measurement reporting (each set is called ReportConfig).

Depending on UE capability, UE may not be able to perform RRM measurement and reception/transmission of other signals (such as PDCCH/PDSCH/PUSCH/PUCCH/SRS etc) simultaneously. For those UEs, network may configure measurement gap during which reception/transmission of signals related with data transmission/reception (PDCCH/PDSCH/PUSCH/PUCCH/SRS) is not performed so that the UE can perform RRM measurement.

For ensuring downlink positioning works, PRS measurement can be configured. PRS measurement may be understood as measurement for positioning that are configured by network/LMF to the terminal in LPP layer. PRS measurement is configured by a set of parameters called PosGapConfig. Measurement gap can be configured for UE to perform PRS measurement.

When UE is operating in high frequency (e.g. FR2), uplink transmission may need to be restricted to meet SAR requirements. For this purpose, UL gap can be configured by GNB. Besides the measurement gap and the UL gap, MUSIM gap can be configured for UE to perform MUSIM related operations during the gap.

During the measurement gap, specific set of DL operations and specific set of UL operations are restricted. During the UL gap, specific set of UL operations are restricted.

Each gap (including measurement gap, UL gap and MUSIM gap etc) pose transmission/reception restrictions on the serving cells associated with the gap.

To meet QoS requirements in the context of the demanding scenarios and traffic characteristics requirements of XR, scheduling restriction during various gaps may need to be alleviated.

One thing to be considered is that gaps are configured to the terminal with certain purposes. Deactivating those gaps recklessly will harm system throughput due to e.g. delayed mobility or delayed reconfiguration that should have done timely manner.

There are number of possible solutions to strike the balance between meeting XR QoS requirement and keeping system maintenance in acceptable level.

UE can be configured with various gaps such as measurement gaps or MUSIM gaps.

Measurement gap temporarily suspends communication with its serving cell to perform measurements on neighboring cells or different frequencies. These gaps ensure seamless mobility and optimal network performance by enabling accurate handovers and signal quality assessments.

MUSIM (Multi-USIM) gap is designed for devices with multiple subscriber identity modules (USIMs). MUSIM gap enables simultaneous operation across different networks or subscriptions. These gaps allow the UE to temporarily suspend communication on one network to perform critical tasks (e.g., paging reception, measurements) for another USIM.

If the UE requires measurement gaps to identify and measure intra-frequency cells and/or inter-frequency cells and/or inter-RAT E-UTRAN cells, and the UE does not support independent measurement gap patterns for different frequency ranges, the network must provide a single per-UE measurement gap pattern for concurrent monitoring of all frequency layers.

If the UE requires measurement gaps to identify and measure intra-frequency cells and/or inter-frequency cells and/or inter-RAT E-UTRAN cells, and the UE supports independent measurement gap patterns for different frequency ranges, the network must provide either per-FR measurement gap patterns for frequency range where UE requires per-FR measurement gap for concurrent monitoring of all frequency layers of each frequency range independently, or a single per-UE measurement gap pattern for concurrent monitoring of all frequency layers of all frequency ranges.

If the UE is configured via LPP to measure PRS for any RSTD, PRS-RSRP, UE Rx-Tx time difference measurement, PRS-RSRPP measurement, RSCP and RSCPD measurement, the network must provide:
>: a single per-UE measurement gap pattern for concurrent monitoring of all positioning frequency layers and intra-frequency, inter-frequency and/or inter-RAT frequency layers of all frequency ranges, or
>: if UE supports independent measurement gap patterns for different frequency ranges for PRS measurement, i.e. supporting independentGapConfigPRS-r17, per-FR measurement gap pattern for the frequency range for concurrent monitoring of all positioning frequency layers and intra-frequency, inter-frequency cells and/or inter-RAT frequency layers in the corresponding frequency range.

During the per-UE measurement gaps, if the measurement gap is activated and not-dropped:
>: the UE is not required to conduct reception/transmission from/to the corresponding E-UTRAN PCell, E-UTRAN SCell(s) and NR serving cells for E-UTRA-NR dual connectivity except the reception of signals used for RRM measurement(s) and the signals used for random access procedure. See MG_op_1.
>: the UE is not required to conduct reception/transmission from/to the corresponding NR serving cells for SA (with single carrier or CA configured) except the reception of signals used for RRM measurement(s), PRS measurement(s) and the signals used for random access procedure. See MG_op_1.
>: the UE is not required to conduct reception/transmission from/to the corresponding PCell, SCell(s) and E-UTRAN serving cells for NR-E-UTRA dual connectivity except the reception of signals used for RRM measurement(s), PRS measurement(s) and the signals used for random access procedure. See MG_op_1.
>: the UE is not required to conduct reception/transmission from/to the corresponding NR serving cells for NR-DC except the reception of signals used for RRM measurement(s), PRS measurement(s) and the signals used for random access procedure. See MG_op_1.

During the per-FR measurement gaps if the measurement gap is activated and not-dropped:
>: the UE is not required to conduct reception/transmission from/to the corresponding E-UTRAN PCell, E-UTRAN SCell(s) and NR serving cells in the corresponding frequency range for E-UTRA-NR dual connectivity except the reception of signals used for RRM measurement(s) and the signals used for random access procedure. See MG_op_1.
>: the UE is not required to conduct reception/transmission from/to the corresponding NR serving cells in the corresponding frequency range for SA (with single carrier or CA configured) except the reception of signals used for RRM measurement(s), PRS measurement(s) and the signals used for random access procedure. See MG_op_1.
>: the UE is not required to conduct reception/transmission from/to the corresponding PCell, SCell(s) and E-UTRAN serving cells in the corresponding frequency range for NR-E-UTRA dual connectivity except the reception of signals used for RRM measurement(s), PRS measurement(s) and the signals used for random access procedure. See MG_op_1.
>: the UE is not required to conduct reception/transmission from/to the corresponding NR serving cells in the corresponding frequency range for NR-DC except the reception of signals used for RRM measurement(s), PRS measurement(s) and the signals used for random access procedure. See MG_op_1.

During the per-UE measurement gaps, if the measurement gap is deactivated or dropped:
>: the UE is required to conduct reception/transmission from/to the corresponding E-UTRAN PCell, E-UTRAN SCell(s) and NR serving cells for E-UTRA-NR dual connectivity except the reception of signals used for RRM measurement(s) and the signals used for random access procedure. See MG_op_2.
>: the UE is required to conduct reception/transmission from/to the corresponding NR serving cells for SA (with single carrier or CA configured) except the reception of signals used for RRM measurement(s), PRS measurement(s) and the signals used for random access procedure. See MG_op_2.
>: the UE is required to conduct reception/transmission from/to the corresponding PCell, SCell(s) and E-UTRAN serving cells for NR-E-UTRA dual connectivity except the reception of signals used for RRM measurement(s), PRS measurement(s) and the signals used for random access procedure. See MG_op_2.
>: the UE is required to conduct reception/transmission from/to the corresponding NR serving cells for NR-DC except the reception of signals used for RRM measurement(s), PRS measurement(s) and the signals used for random access procedure. See MG_op_2.

During the per-FR measurement gaps if the measurement gap is activated and not-dropped:
>: the UE is required to conduct reception/transmission from/to the corresponding E-UTRAN PCell, E-UTRAN SCell(s) and NR serving cells in the corresponding frequency range for E-UTRA-NR dual connectivity except the reception of signals used for RRM measurement(s) and the signals used for random access procedure. See MG_op_2.
>: the UE is required to conduct reception/transmission from/to the corresponding NR serving cells in the corresponding frequency range for SA (with single carrier or CA configured) except the reception of signals used for RRM measurement(s), PRS measurement(s) and the signals used for random access procedure. See MG_op_2.
>: the UE is required to conduct reception/transmission from/to the corresponding PCell, SCell(s) and E-UTRAN serving cells in the corresponding frequency range for NR-E-UTRA dual connectivity except the reception of signals used for RRM measurement(s), PRS measurement(s) and the signals used for random access procedure. See MG_op_2.
>: the UE is required to conduct reception/transmission from/to the corresponding NR serving cells in the corresponding frequency range for NR-DC except the reception of signals used for RRM measurement(s), PRS measurement(s) and the signals used for random access procedure. See MG_op_2.

### Pre-Configured Measurement Gap

A UE capable of Pre-configured measurement gap (Pre-MG) pattern can be configured with a Pre-MG pattern via RRC signalling.

The gap interruption requirements apply to Pre-MG when Pre-MG is activated and not dropped. No gap interruption is expected when Pre-MG is deactivated or activated and dropped.

Pre-MG is configured by a type 1 GapConfig-r17 IE. The type 1 GapConfig-r17 IE is a GapConfig-r17 that includes preConfigInd-r17.

A measurement gap is configured as pre-configured measurement gap if preConfigInd is indicated by network in the configuration message of the measurement gap.

If UE indicates support of only preconfiguredNW-ControlledMeasGap, UE can expect the network to configure preConfGapStatus.

When a pre-configured measurement gap is used to perform PRS measurements, the UE will inform the network that it is going to start/stop PRS measurements with the configured pre-configured measurement gap by initiating the existing LocationMeasurementIndication procedure.

If the Pre-MG status changes during a measurement period of a measurement that can be performed without and within measurement gaps, the UE is allowed to restart the measurement.

If the Pre-MG status changes from activated to deactivated during a measurement period of a measurement that can only be performed within measurement gaps, the measurement requirements do not apply.

Concurrent measurement gap is necessary to enable the UE to simultaneously monitor and measure multiple frequency layers (intra-frequency, inter-frequency, and inter-RAT cells) within a single gap pattern, ensuring efficient resource utilization and seamless mobility across different networks.

When UE supports concurrent measurement gap pattern capability, network can provide multiple measurement gaps configured by RRC message(s). When UE supports concurrent measurement gap pattern capability, the network can provide multiple measurement gaps configured by RRC message(s), and the UE reports its concurrent gap capability by indicating the Gap Combination Configuration Id.

The base station can configure concurrent gaps by referring to the GCC id reported by the UE, and in that GCC configuration, when the base station cancels or resumes MGs using DCI, the MGs are cancelled or resumed as follows, where resuming means that the cancelled MGs are restored to their original state.

MG_SET is determined as below.
For GCC Id 0, the configuration includes two Per-FR1 measurement gaps, one Per-FR2 measurement gap, and zero Per-UE measurement gaps. When DCI with tentative drop set to 1 is received in an FR1 serving cell, the Per-FR1 measurement gaps are deactivated or dropped. Similarly, when such DCI is received in an FR2 serving cell, the Per-FR2 measurement gaps are deactivated or dropped. For resumption, when DCI with tentative drop set to 0 is received in an FR1 serving cell, the Per-FR1 measurement gaps are resumed, and when received in an FR2 serving cell, the Per-FR2 measurement gaps are resumed.
For GCC Id 1, the configuration consists of one Per-FR1 measurement gap, two Per-FR2 measurement gaps, and zero Per-UE measurement gaps. The cancellation and resumption behavior follows the same pattern as GCC Id 0, where DCI reception in FR1 or FR2 serving cells affects the corresponding frequency range measurement gaps.
For GCC Id 2, the configuration includes zero Per-FR1 measurement gaps, zero Per-FR2 measurement gaps, and two Per-UE measurement gaps. When DCI with tentative drop set to 1 is received in either an FR1 or FR2 serving cell, all Per-UE measurement gaps are deactivated or dropped. Similarly, when DCI with tentative drop set to 0 is received in either frequency range, the Per-UE measurement gaps are resumed.
For GCC Id 3, the configuration comprises one Per-FR1 measurement gap, zero Per-FR2 measurement gaps, and one Per-UE measurement gap. When DCI with tentative drop set to 1 is received in an FR1 serving cell, both Per-FR1 and Per-UE measurement gaps are deactivated or dropped. However, when such DCI is received in an FR2 serving cell, only the Per-UE measurement gaps are deactivated or dropped. For resumption, when DCI with tentative drop set to 0 is received in an FR1 serving cell, both Per-FR1 and Per-UE measurement gaps are resumed, while reception in an FR2 serving cell resumes only the Per-UE measurement gaps.
For GCC Id 4, the configuration includes zero Per-FR1 measurement gaps, one Per-FR2 measurement gap, and one Per-UE measurement gap. When DCI with tentative drop set to 1 is received in an FR2 serving cell, both Per-FR2 and Per-UE measurement gaps are deactivated or dropped. When received in an FR1 serving cell, only the Per-UE measurement gaps are deactivated or dropped. The resumption behavior mirrors this pattern, where DCI with tentative drop set to 0 received in an FR2 serving cell resumes both Per-FR2 and Per-UE measurement gaps, while reception in an FR1 serving cell resumes only the Per-UE measurement gaps.
For GCC Id 5, the configuration consists of one Per-FR1 measurement gap, one Per-FR2 measurement gap, and one Per-UE measurement gap. When DCI with tentative drop set to 1 is received in an FR2 serving cell, both Per-FR2 and Per-UE measurement gaps are deactivated or dropped. When received in an FR1 serving cell, both Per-FR1 and Per-UE measurement gaps are deactivated or dropped. For resumption, DCI with tentative drop set to 0 received in an FR2 serving cell resumes both Per-FR2 and Per-UE measurement gaps, while reception in an FR1 serving cell resumes both Per-FR1 and Per-UE measurement gaps.
For GCC Id 6, the configuration includes two Per-FR1 measurement gaps, zero Per-FR2 measurement gaps, and zero Per-UE measurement gaps. When DCI with tentative drop set to 1 is received in an FR1 serving cell, the Per-FR1 measurement gaps are deactivated or dropped. When DCI with tentative drop set to 0 is received in an FR1 serving cell, the Per-FR1 measurement gaps are resumed.
For GCC Id 7, the configuration comprises zero Per-FR1 measurement gaps, two Per-FR2 measurement gaps, and zero Per-UE measurement gaps. When DCI with tentative drop set to 1 is received in an FR2 serving cell, the Per-FR2 measurement gaps are deactivated or dropped. When DCI with tentative drop set to 0 is received in an FR2 serving cell, the Per-FR2 measurement gaps are resumed.

Collisions between occasions of two concurrent measurement gaps may occur as specified in this clause if the two measurement gaps are:
>: two per-UE measurement gaps, or
>: two per-FR measurement gaps in the same FR, or
>: one per-UE measurement gap and one per-FR measurement gap.

When UE is configured with concurrent measurement gaps, two measurement gap occasions are considered colliding if at least one of the following conditions is met:
>: the two occasions are fully or partially overlapping in time domain, or
>: the distance between the two occasions is equal to or smaller than 4 ms.

The distance between two measurement gap occasions is defined as the time difference between the ending point of the first occasion and the starting point of the second occasion, where the first measurement gap occasion occurs earlier in time than the second measurement gap occasion.

In case of collision between two measurement gap occasions, the UE shall perform measurements in the occasion of the measurement gap with higher priority, and the occasion of the measurement gap with lower priority shall be dropped. The UE shall be able to transmit PUCCH/PUSCH/SRS or receive PDCCH/PDSCH/TRS/CSI-RS for CQI in the corresponding NR serving cells in the slots that are not interrupted according to requirements.

The requirements of concurrent measurement gaps in section 9 shall not apply when a gap without assigned priority is configured simultaneously with any other gap(s) that affect serving carriers in the same FR and the measurement gaps are colliding with each other.

The priority for a measurement gap is configured by networks via gapPriority in GapConfig. The requirements with concurrent measurement gaps apply provided that two measurement gaps colliding with each other are configured with different priorities.

One or more MGs can be configured concurrently. Each concurrent MG is configured by a type 2 GapConfig-r17 IE. The type 2 GapConfig-r17 IE is a GapConfig-r17 IE that includes neither preConfigInd-r17 nor ncsgInd-r17.

### Positioning Measurement Gap

The UE can be pre-configured with a positioning measurement gap patterns via RRC signalling.

The UE can activate or deactivate the preconfigured positioning measurement gaps via MAC CE.

If the UE requires gap patterns for MUSIM purpose, such as cell identification and measurement, paging monitoring, SIB acquisition, and/or on-demand SI request of the target cell in the target network, then the network may provide one or more per-UE MUSIM gap pattern(s) for concurrent monitoring of all frequency layers for MUSIM via MUSIM-GapConfig. The UE can be configured with no more than three periodic MUSIM gap patterns and/or one aperiodic MUSIM gap pattern for MUSIM via MUSIM-GapConfig.

The UE is not required to perform cell identification and measurement, paging monitoring, SIB acquisition, and/or on-demand SI request of the target cell in the target network that is outside the MUSIM gaps. The UE is not required to conduct reception or transmission from or to the [source] network during MUSIM gaps that are not dropped due to collisions.

Priority levels are applied for each periodic MUSIM gap. A UE shall request a priority for all requested periodic MUSIM gaps when the UE requests MUSIM gaps via MUSIM-GapConfig-r17. The UE shall request different priority level for each periodic MUSIM gaps. The network may assign priority to each periodic MUSIM gaps. The allocated priorities may differ from the priorities requested by the UE. The UE MUSIM requirements apply if the configured MUSIM gap priorities retain the same relative priorities among MUSIM gaps as requested by the UE.

An aperiodic MUSIM gap, when configured, is unconditionally kept in case of collisions with any other gap occasions, including MUSIM gaps and measurement gaps.

The UE can request use of “keep solution” via musim-GapKeepPreference. Keep solution is for handling collisions among different MUSIM gaps. If the use of “keep solution” is granted, the UE shall keep all colliding periodic and aperiodic MUSIM gaps irrespectively of the priority of the periodic MUSIM gaps.

MUSIM gap occasions are considered colliding if at least one of the following conditions is met:
>: the MUSIM gap occasions are fully overlapping in time domain, or
>: the MUSIM gap occasions partially overlapping in time domain, or
>: the distance between the two MUSIM gap occasions is equal to or smaller than 4 ms.

The distance between two MUSIM gap occasions is defined as the time difference between the ending point of the first occasion and the starting point of the second occasion, where the first MUSIM gap occasion occurs earlier in time than the second MUSIM gap occasion.

MUSIM gap and measurement gap occasions are considered colliding if at least one of the following conditions is met:
>: the MUSIM gap and measurement gap occasions are fully overlapping in time domain, or
>: the MUSIM gap and measurement gap occasions are partially overlapping in time domain, or
>: the distance between any of the MUSM gap and the measurement gap occasions is equal to or smaller than 4 ms.

The distance between two gap occasions is defined as the time difference between the ending point of the first occasion and the starting point of the second occasion, where the first gap occasion occurs earlier in time than the second gap occasion. The gap occasion can be either a MUSIM gap occasion or a measurement gap occasion.

The measurement gap occasion colliding with an aperiodic MUSIM gap is dropped.

Collisions between MUSIM gaps and measurement gaps configured via GapConfig-r17 with assigned priority but without preConfigInd-r17 or ncsgInd-r17 are handled based on their assigned priorities. Collisions are resolved sequentially in order of decreasing priority, starting with the gap that has the highest priority. For each collision, the occasion of the MUSIM gap or measurement gap with highest priority shall be kept and the occasion of the MUSIM gap or measurement gap with lower priority shall be dropped. Any collisions between MUSIM gaps shall be addressed as specified in clause 9.1.10.3 and 9.1.10.4. When “keep solution” in clause 9.1.10.3 is configured, keep solution is used for the remaining collided and non-dropped MUSIM gaps, after resolving the collisions between measurement gaps and MUSIM gaps based on their priorities.

Collisions between MUSIM gaps and measurement gaps configured via GapConfig or configured via GapConfig-r17 without assigned priority are handled based on MGRP of the colliding gaps. Collisions are resolved sequentially in order of decreasing MGRP, starting with the gap that has the longest MGRP. For each collision, the occasion of the MUSIM gap or measurement gap with longer MGRP shall be kept and the occasion of the MUSIM gap or measurement gap with shorter MGRP shall be dropped. If the colliding MUSIM gap and measurement gap have the same MGRP, the requirements in clause 9 shall not apply. Any collisions between MUSIM gaps shall be addressed as specified in clause 9.1.10.3 and 9.1.10.4. When “keep solution” in clause 9.1.10.3 is configured, keep solution is used for the remaining collided and non-dropped MUSIM gaps, after resolving the collisions between measurement gaps and MUSIM gaps based on their MGRP.

An uplink gap consists of consecutive static UL slot(s) in one or more TDD-UL-DL-Pattern duration, starting from the first static UL slot of an UL gap repetition period. UGL is the aggregated length of consecutive UL slots used as the UL gap within an UL gap repetition period. That means, there can be a DL slot and/or special slot but no static UL slot between the two consecutive static UL slots within the UL gap length.

When an UL gap overlaps with an uplink transmission in NR serving cells in FR2 single CC or FR2 intra-band CA or FR2 inter-band CA where UE does not support tx-Support-UL-GapFR2-r17, then the UE is not required to conduct any transmission during the UL gap on the NR serving cells other than those listed in Clause 5.30 in TS 38.321 [7].

### Definitions/Operation-Sets

[Intra-Frequency SSB Based Measurement without Gaps]

The UE can perform intra-frequency SSB based measurements without measurement gaps if:
>: CD-SSB is within the configured UE-specific CBW, or
>: NCD-SSB is completely contained in the active downlink BWP of the UE or
>: the UE indicates ‘no-gap’ via intraFreq-needForGap for intra-frequency measurement, or
>: the SSB is completely contained in the active BWP of the UE, or
>: the active downlink BWP is initial BWP.
   [Intra-Frequency SSB Based Measurement with Gaps]

An intra-frequency SSB measurement is defined as measurement with NCSG if
>: the UE indicates ‘ncsg’ via NeedForGapNCSG-InfoNR for the intra-frequency measurement, and
>: the SSB is not completely contained in the active BWP of the UE, and
>: the active downlink BWP is not an initial BWP

An intra-frequency SSB measurement is defined as measurement with gap if
>: the UE indicates ‘gap’ via NeedForGapNCSG-InfoNR for the intra-frequency measurement, and
>: the SSB is not completely contained in the active BWP of the UE, and
>: the active downlink BWP is not an initial BWP
   [Inter-Frequency SSB Based Measurement without Gaps]

A measurement is defined as an inter-frequency SSB based measurements without measurement gaps (either legacy measurement gap or NCSG) in active BWP, for UE capable of interFrequencyMeas-NoGap provided that:
>: the UE supports interFrequencyMeas-Nogap-r16 [15], and
>: the SSB is completely contained in the active BWP of the UE.
>: For inter-frequency SSB based measurements without measurement gaps, UE may cause scheduling restriction

An inter-frequency SSB measurement is defined as measurement without gap if
>: the UE indicates ‘nogap-noncsg’ via NeedForGapNCSG-InfoNR for the inter-frequency measurement, and
>: the SSB is not completely contained in the active BWP of the UE
>: For inter-frequency SSB based measurements without MG and NCSG, UE may cause scheduling restriction.
   <Inter-Frequency SSB Based Measurement with Gaps>
>: An inter-frequency SSB measurement is defined as measurement with NCSG if
>>: the UE indicates ‘ncsg’ via NeedForGapNCSG-InfoNR for the inter-frequency measurement, and
>>: the SSB is not completely contained in the active BWP of the UE
>>: For inter-frequency SSB based measurements with NCSG, UE may cause scheduling restriction as specified in clause 9.3.10.3.
>: An inter-frequency SSB measurement is defined as measurement with gap if
>>: the UE indicates ‘gap’ via NeedForGapNCSG-InfoNR for the inter-frequency measurement, and
>>: the SSB is not completely contained in the active BWP of the UE

### [SA_intra (Scheduling Availability of UE During Intra-Frequency Measurements)]

UE shall be capable of measuring without measurement gaps when the SSB is completely contained in the active bandwidth part of the UE, or the UE indicates no-gap-no-interruption for intra-frequency measurement, or the UE indicates no-gap-with-interruption for intra-frequency measurement. When any of the conditions in the following clauses is met, there are restrictions on the scheduling availability; otherwise, there is no scheduling restriction. Note that the SSB symbols indicated by the union set of SSB-ToMeasure from all the configured measurement objects on the same serving carrier which can be merged, if it is configured; otherwise, all L SSB symbols within the SMTC window duration defined in clause 4.1 of TS 38.213 are included.

For a UE that supports Pre-MG, the requirements on <Scheduling availability of UE during intra-frequency measurements> also apply when a Pre-MG is deactivated.

For UE supporting concurrent measurement gaps, when concurrent gaps are configured, the requirements on <Scheduling availability of UE during intra-frequency measurements> are also applied to the slots that are not interrupted.

For UE supporting MUSIM gaps, when MUSIM gaps are configured, the requirements on <Scheduling availability of UE during intra-frequency measurements> are also applied to the slots that are not.

### [Scheduling Availability of UE Performing Measurements in TDD Bands on FR1]

When the UE performs intra-frequency measurements in a TDD band, the following restrictions apply due to SS-RSRP or SS-SINR measurement

The UE is not expected to transmit PUCCH/PUSCH/SRS on SSB symbols to be measured, and on 1 data symbol before each consecutive SSB symbols to be measured and 1 data symbol after each consecutive SSB symbols to be measured within SMTC window duration. If the high layer in TS 38.331 signalling of smtc2 is configured, the SMTC periodicity follows smtc2; Otherwise SMTC periodicity follows smtc1.

When the UE performs intra-frequency measurements in a TDD band, the following restrictions apply due to SS-RSRQ measurement

The UE is not expected to transmit PUCCH/PUSCH/SRS on SSB symbols to be measured, RSSI measurement symbols, and on 1 data symbol before each consecutive SSB to be measured/RSSI symbols and 1 data symbol after each consecutive SSB to be measured/RSSI symbols within SMTC window duration. If the high layer signalling of smtc2 is configured in TS 38.331, the SMTC periodicity follows smtc2; Otherwise the SMTC periodicity follows smtc1.

When TDD intra-band carrier aggregation is performed, the scheduling restrictions due to a given serving cell also apply to all other serving cells in the same band on the symbols that fully or partially overlap with the aforementioned restricted symbols.

When intra-band non-contiguous carrier aggregation is configured for a UE indicating intraBandNR-CA-non-collocated-r18 and if nonCollocatedTypeNR-CA-r18 is not provided, there are no scheduling restrictions on FR1 serving cell(s) to be measured and configured on the non-contiguous CC(s) in the same band. Otherwise, the scheduling restrictions due to a given serving cell also apply to all other serving cells in the same band on the symbols that fully or partially overlap with the aforementioned restricted symbols if nonCollocatedTypeNR-CA-r18 is provided.

When TDD inter-band carrier aggregation is performed, the scheduling restrictions due to a given serving cell also apply to another serving cell in a different band on the symbols that fully or partially overlap with the aforementioned restricted symbols, if UE does not have the capability of supporting simultaneousRxTxInterBandCA for this band pair.

When inter-band FR1+FR1 NR-DC is performed, the scheduling restrictions due to a given serving cell also apply to another serving cell in a different band on the symbols that fully or partially overlap with the aforementioned restricted symbols, if UE does not have the capability of supporting simultaneousRxTxInterBandCA for this band pair.

[Scheduling Availability of UE Performing Measurements with a Different Subcarrier Spacing than PDSCH/PDCCH on FR1]

For UE which do not support simultaneousRxDataSSB-DiffNumerology the following restrictions apply due to SS-RSRP/RSRQ/SINR measurement

If deriveSSB_IndexFromCell is enabled the UE is not expected to transmit PUCCH/PUSCH/SRS or receive PDCCH/PDSCH/TRS/CSI-RS for CQI on SSB symbols to be measured, and on 1 data symbol before each consecutive SSB symbols to be measured and 1 data symbol after each consecutive SSB symbols to be measured within SMTC window duration. If the high layer signalling of smtc2 is configured (in TS 38.331), the SMTC periodicity follows smtc2; Otherwise the SMTC periodicity follows smtc1.

If deriveSSB_IndexFromCell is not enabled the UE is not expected to transmit PUCCH/PUSCH/SRS or receive PDCCH/PDSCH/TRS/CSI-RS for CQI on all symbols within SMTC window duration. If the high layer signalling of smtc2 is configured in TS 38.331, the SMTC periodicity follows smtc2; Otherwise the SMTC periodicity follows smtc1.

If the following conditions are met:
The UE has been notified about system information update through paging,
The gap between the UE's reception of PDCCH that UE monitors in the Type 2-PDCCH CSS set that notifies system information update, and the PDCCH that UE monitors in the Type0-PDCCH CSS set, is greater than 2 slots
The UE shall receive the PDCCH that the UE monitors in the Type0-PDCCH CSS set, and/or the corresponding PDSCH, on SSB symbols to be measured.

When intra-band carrier aggregation is performed, the scheduling restrictions due to a given serving cell also apply to all other serving cells in the same band on the symbols that fully or partially overlap with the aforementioned restricted symbols.

When intra-band non-contiguous carrier aggregation is configured for a UE indicatingintraBandNR-CA-non-collocated-r18 and if nonCollocatedTypeNR-CA-r18 is not provided, there are no scheduling restrictions on FR1 serving cell(s) to be measured and configured on the non-contiguous CC(s) in the same band. Otherwise, the scheduling restrictions due to a given serving cell also apply to all other serving cells in the same band on the symbols that fully or partially overlap with the aforementioned restricted symbols if nonCollocatedTypeNR-CA-r18 is provided.

### [Scheduling Availability of UE Performing Measurements on FR2]

### The Following Scheduling Restriction Applies Due to SS-RSRP or SS-SINR Measurement on an FR2 Intra-Frequency Cell

If deriveSSB-IndexFromCell is enabled the UE is not expected to transmit PUCCH/PUSCH/SRS or receive PDCCH/PDSCH/TRS/CSI-RS for CQI on SSB symbols to be measured, and on K data symbol(s) before each consecutive SSB symbols to be measured and K data symbol(s) after each consecutive SSB symbols to be measured within SMTC window duration.
If deriveSSB-IndexFromCell is not enabled and the SCS of data and SSB symbols are smaller than 960 kHz, the UE is not expected to transmit PUCCH/PUSCH/SRS or receive PDCCH/PDSCH/TRS/CSI-RS for CQI on all symbols within SMTC window duration.
If deriveSSB-IndexFromCell is not enabled and the SCS of data or SSB symbols is 960 kHz, the UE is not expected to transmit PUCCH/PUSCH/SRS or receive PDCCH/PDSCH/TRS/CSI-RS for CQI SSB symbols to be measured, and on K′ data symbol(s) before each consecutive SSB symbols to be measured and K′ data symbol(s) after each consecutive SSB symbols to be measured within SMTC window duration.

### The Following Scheduling Restriction Applies to SS-RSRQ Measurement on an FR2 Intra-Frequency Cell

If deriveSSB-IndexFromCell is enabled the UE is not expected to transmit PUCCH/PUSCH/SRS or receive PDCCH/PDSCH/TRS/CSI-RS for CQI on SSB symbols to be measured, RSSI measurement symbols, and on K data symbol(s) before each consecutive SSB to be measured/RSSI symbols and K data symbol(s) after each consecutive SSB to be measured/RSSI symbols within SMTC window duration
If deriveSSB-IndexFromCell is not enabled and the SCS of data and SSB symbols are smaller than 960 kHz, the UE is not expected to transmit PUCCH/PUSCH/SRS or receive PDCCH/PDSCH/TRS/CSI-RS for CQI on all symbols within SMTC window duration.
If deriveSSB-IndexFromCell is not enabled and the SCS of SSB symbols is 960 kHz, the UE is not expected to transmit PUCCH/PUSCH/SRS or receive PDCCH/PDSCH/TRS/CSI-RS for CQI on SSB symbols to be measured, RSSI measurement symbols, and on K′ data symbol(s) before each consecutive SSB to be measured/RSSI symbols and K′ data symbol(s) after each consecutive SSB to be measured/RSSI symbols within SMTC window duration.
where
If the high layer signalling of smtc2 is configured in TS 38.331, the SMTC periodicity follows smtc2; Otherwise the SMTC periodicity follows smtc1.

The signaling deriveSSB-IndexFromCell is always enabled for FR2-1 and FR2-2 when SSB is using 120 kHz SCS and 480 kHz SCS.
K=1 for a serving cell with data symbols of 120 kHz SCS
K=4 for a serving cell with data symbols of 480 kHz SCS and SSB symbols of 120 kHz or 480 kHz SCS
K=3 for a serving cell with data symbols of 480 kHz SCS and SSB symbols of 960 kHz SCS
K=7 for a serving cell with data symbols of 960 kHz SCS and SSB symbols of 120 kHz or 480 kHz SCS
K=4 for a serving cell with data symbols of 960 kHz SCS and SSB symbols of 960 kHz SCS
K′=2 for a serving cell with data symbols of 120 kHz SCS and SSB symbols of 960 kHz SCS
K′=4 for a serving cell with data symbols of 480 kHz SCS and SSB symbols of 960 kHz SCS
K′=7 for a serving cell with data symbols of 960 kHz SCS and SSB symbols of 960 kHz SCS

When intra-band carrier aggregation in FR2 is performed, the scheduling restrictions due to a given serving cell also apply to all other serving cells in the same band on the symbols that fully or partially overlap with aforementioned restricted symbols.

When inter-band carrier aggregation in FR2 is performed, there are no scheduling restrictions on FR2 serving cells in the bands due to SS-RSRP, SS-RSRQ or SS-SINR measurement on an FR2 intra-frequency cell in different bands, provided that UE is capable of independent beam management on this FR2 band pair. Additionally, there is no scheduling restriction if the UE is configured with different numerology between SSB on one FR2 band and data on the other FR2 band provided the UE is configured for IBM operation for the band pair.

If following conditions are met:
The UE has been notified about system information update through paging,
The gap between the UE's reception of PDCCH that UE monitors in the Type 2-PDCCH CSS set that notifies system information update, and the PDCCH that UE monitors in the Type0-PDCCH CSS set, is greater than 2 slots
For the SSB and CORESET for RMSI scheduling multiplexing patterns 3, the UE shall receive the PDCCH that the UE monitors in the Type0-PDCCH CSS set, and the corresponding PDSCH, on SSB symbols to be measured; and
For the SSB and CORESET for RMSI scheduling multiplexing patterns 2, the UE shall receive PDSCH that corresponds to the PDCCH that the UE monitors in the Type0-PDCCH CSS set, on SSB symbols to be measured.

### [Scheduling Availability of UE Performing Measurements on FR1 or FR2 in Case of FR1-FR2 Inter-Band CA]

There are no scheduling restrictions on FR1 serving cell(s) due to measurements performed on FR2 serving cell frequency layer. However, the scheduling restrictions as defined in <Scheduling availability of UE performing measurements in TDD bands on FR1> due to a given serving cell in FR2 also apply to another serving cell in an FR1 band on the symbols that fully or partially overlap with the aforementioned restricted symbols, if UE does not have the capability of supporting simultaneousRxTxInterBandCA for this FR1-FR2 band pair.

There are no scheduling restrictions on FR2 serving cell(s) due to measurements performed on FR1 serving cell frequency layer. However, the scheduling restrictions as defined in clause <Scheduling availability of UE performing measurements in TDD bands on FR1> due to a given serving cell in FR1 also apply to another serving cell in an FR2 band on the symbols that fully or partially overlap with the aforementioned restricted symbols, if UE does not have the capability of supporting simultaneousRxTxInterBandCA for this FR1-FR2 band pair.

[SA_inter (Scheduling Availability of UE During Inter-Frequency Measurements when the SSB is Completely Contained in the Active BWP of the UE)]

If UE supports interFrequencyMeas-NoGap-r16 and the flag interFrequencyConfig-NoGap-r16 is configured by the Network, UE is required to be capable of measuring without measurement gaps when the SSB is completely contained in the active bandwidth part of the UE. When any of the conditions in the following clauses is met, there are restrictions on the scheduling availability; otherwise, there is no scheduling restriction. Note that the SSB symbols to be measured in the following clauses are the SSB symbols indicated by SSB-ToMeasure, if it is configured; otherwise, all L SSB symbols within the SMTC window duration defined in clause 4.1 of TS 38.213 are included.

The scheduling availability requirements when UE performs inter-frequency measurements without measurement gaps in a TDD bands on FR1 and FR2 in following clauses are valid under the following conditions:
SFN and frame boundary across serving cell and inter-frequency neighbor cells is aligned.

### [Scheduling Availability of UE Performing Measurements in TDD Bands on FR1]

When UE performs inter-frequency measurements without measurement gaps in a TDD band, the following restrictions apply due to SS-RSRP or SS-SINR measurement.

UE is not expected to transmit PUCCH/PUSCH/SRS on SSB symbols to be measured, and on 1 data symbol before each consecutive SSB symbols to be measured and 1 data symbol after each consecutive SSB symbols to be measured within SMTC window duration.

When UE performs inter-frequency measurements without measurement gaps in a TDD band, the following restrictions apply due to SS-RSRQ measurement

UE is not expected to transmit PUCCH/PUSCH/SRS on SSB symbols to be measured, RSSI measurement symbols, and on 1 data symbol before each consecutive SSB to be measured/RSSI symbols and 1 data symbol after each consecutive SSB to be measured/RSSI symbols within SMTC window duration.

When TDD intra-band carrier aggregation is performed, the scheduling restrictions due to one serving cell also apply to all other serving cells in the same band on the symbols that fully or partially overlap with aforementioned restricted symbols.

When intra-band non-contiguous carrier aggregation is configured for a UE indicating intraBandNR-CA-non-collocated-r18 and if nonCollocatedTypeNR-CA-r18 is not provided, there are no scheduling restrictions on FR1 serving cell(s) to be measured and configured on the non-contiguous CC(s) in the same band. Otherwise, the scheduling restrictions due to one serving cell also apply to all other serving cells in the same band on the symbols that fully or partially overlap with aforementioned restricted symbols if nonCollocatedTypeNR-CA-r18 is provided

[Scheduling Availability of UE Performing Measurements with a Different Subcarrier Spacing than PDSCH/PDCCH on FR1]

For UE which do not support simultaneousRxDataSSB-DiffNumerology-Inter-r16 the following restrictions apply due to SS-RSRP/RSRQ/SINR measurement

If UE performs inter-frequency measurements without measurement gaps in a TDD band, UE is not expected to transmit PUCCH/PUSCH/SRS or receive PDCCH/PDSCH/TRS/CSI-RS for CQI on SSB symbols to be measured, and on 1 data symbol before each consecutive SSB symbols to be measured and 1 data symbol after each consecutive SSB symbols to be measured within SMTC window duration.

If UE performs inter-frequency measurements without measurement gaps in a FDD band, UE is not expected to transmit PUCCH/PUSCH/SRS or receive PDCCH/PDSCH/TRS/CSI-RS for CQI on the union of restricted serving cell symbols due to measurement of all MOs, where the restricted serving cell symbols due to measurement of MO i include
serving cell symbols fully or partially overlap with SSB symbols to be measured on MO i, and Δt serving cell symbol before each consecutive SSB symbols to be measured and Δt serving cell symbol after each consecutive SSB symbols to be measured within SMTC window duration, if deriveSSB-IndexFromCellInter-r17 is enabled for MO i and UE supporting deriveSSB-IndexFromCellInterNon-NCSG-r17. Δt is defined as the minimum integer number of symbols with total duration no smaller than the tolerance specified in clause 7.9, or
serving cell symbols fully or partially overlap with SMTC window for MO i and on 1 serving cell symbol before and after the SMTC window, if deriveSSB-IndexFromCellInter-r17 is not enabled for MO i, or UE not supporting deriveSSB-IndexFromCellInterNon-NCSG-r17.

When intra-band carrier aggregation is performed, the scheduling restrictions due to a given serving cell also apply to all other serving cells in the same band on the symbols that fully or partially overlap with aforementioned restricted symbols.

When intra-band non-contiguous carrier aggregation is configured for a UE indicating intraBandNR-CA-non-collocated-r18 and if nonCollocatedTypeNR-CA-r18 is not provided, there are no scheduling restrictions on FR1 serving cell(s) to be measured and configured on the non-contiguous CC(s) in the same band. Otherwise, the scheduling restrictions due to a given serving cell also apply to all other serving cells in the same band on the symbols that fully or partially overlap with aforementioned restricted symbols if nonCollocatedTypeNR-CA-r18 is provided.

### [Scheduling Availability of UE Performing Measurements on FR2]

### The Following Scheduling Restriction Applies Due to SS-RSRP or SS-SINR Measurement on an FR2 Inter-Frequency Cell

The UE is not expected to transmit PUCCH/PUSCH/SRS or receive PDCCH/PDSCH/TRS/CSI-RS for CQI on SSB symbols to be measured, and on 1 data symbol before each consecutive SSB symbols to be measured and 1 data symbol after each consecutive SSB symbols to be measured within SMTC window duration.

### The Following Scheduling Restriction Applies to SS-RSRQ Measurement on an FR2 Inter-Frequency Cell

The UE is not expected to transmit PUCCH/PUSCH/SRS or receive PDCCH/PDSCH/TRS/CSI-RS for CQI on SSB symbols to be measured, RSSI measurement symbols, and on 1 data symbol before each consecutive SSB to be measured/RSSI symbols and 1 data symbol after each consecutive SSB to be measured/RSSI symbols within SMTC window duration.

When intra-band carrier aggregation is performed, the scheduling restrictions due to a given serving cell also apply to all other serving cells in the same band on the symbols that fully or partially overlap with aforementioned restricted symbols.

If following conditions are met:
The UE has been notified about system information update through paging,
The gap between the UE's reception of PDCCH that UE monitors in the Type 2-PDCCH CSS set that notifies system information update, and the PDCCH that UE monitors in the Type0-PDCCH CSS set, is greater than 2 slots.
For the SSB and CORESET for RMSI scheduling multiplexing patterns 3, the UE shall receive the PDCCH that the UE monitors in the Type0-PDCCH CSS set, and the corresponding PDSCH, on SSB symbols to be measured; and
For the SSB and CORESET for RMSI scheduling multiplexing patterns 2, the UE shall receive PDSCH that corresponds to the PDCCH that the UE monitors in the Type0-PDCCH CSS set, on SSB symbols to be measured.
There are no scheduling restrictions on FR1 serving cell(s) due to measurements performed on FR2 serving cell frequency layer.
There are no scheduling restrictions on FR2 serving cell(s) due to measurements performed on FR1 serving cell frequency layer.

### [MG_op_1]

During an activated/not-dropped measurement gap, the MAC entity shall, on the Serving Cell(s) in the corresponding frequency range of the measurement gap configured by measGapConfig as specified in TS 38.331:
>: not perform the transmission of HARQ feedback, SR, and CSI;
>: not report SRS;
>: not transmit on UL-SCH except for Msg3 or the MSGA payload as specified in clause 5.4.2.2;
>: if the ra-ResponseWindow or the ra-ContentionResolutionTimer or the msgB-ResponseWindow is running, or if there is an ongoing RACH-less LTM cell switch, or if there is an ongoing RACH-less handover:
>>: monitor the PDCCH.
>: else:
>>: not monitor the PDCCH;

UE performs MG_op_1 during a measurement gap in case that:
>: the measurement gap is pre-MG, the measurement gap is configured by RRC message, the UE determines that the measurement gap is activated, and the measurement gap is not dropped;
>: the measurement gap is NCSG, the measurement gap is configured by RRC message, and the measurement gap is not dropped; or
>: the measurement gap is a positioning measurement gap, the measurement gap is configured by RRC message, the measurement gap is activated by a MAC CE, and the measurement gap is not dropped.

### [MG_op_2]

During an activated/dropped measurement gap, the MAC entity shall, on the Serving Cell(s) in the corresponding frequency range of the measurement gap configured by measGapConfig as specified in TS 38.331:
>: perform the transmission of HARQ feedback, SR, and CSI;
>: report SRS;
>: transmit on UL-SCH;
>: monitor the PDCCH;

UE performs MG_op_2 during a measurement gap in case that:
>: the measurement gap is pre-MG and the measurement gap is configured by RRC message:
>>: the UE determines that the measurement gap is activated, and the measurement gap is dropped; or
>>: the UE determines that the measurement gap is deactivated;
>: the measurement gap is NCSG, the measurement gap is configured by RRC message, and the measurement gap is dropped; or
>: the measurement gap is a positioning measurement gap and the measurement gap is configured by RRC message:
>>: the measurement gap is activated by a MAC CE, and the measurement gap is dropped; or
>> the measurement gap is deactivated by the MAC CE.

### [MUSIM_op_1]

The UE performs cell identification and measurement, paging monitoring, SIB acquisition, and/or on-demand SI request of the target cell in the target network;

The UE performs [MG_op_1] in the source network.

### [MUSIM_op_2]

The UE does not perform cell identification and measurement, paging monitoring, SIB acquisition, and/or on-demand SI request of the target cell in the target network;

The UE performs [MG_op_2] in the source network.

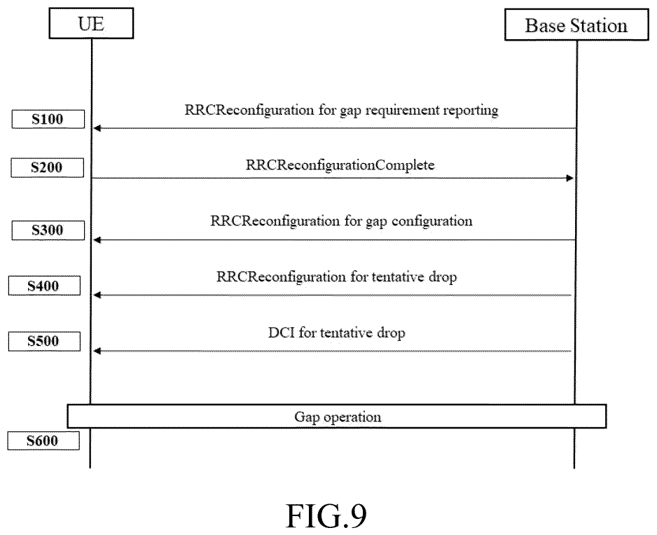

FIG. 9 illustrates operations of UE and base station.

Followings are used interchangeably.
>: That gap is deactivated, that gap is dropped and that gap is cancelled;
>: gap and MG;
>: That xxx is dropped, that xxx is not applied and that xxx is canceled;
>: That xxx is not dropped, that xxx is applied and that xxx is not canceled;

UE receives a specific DCI in a specific serving cell.
>: The specific DCI is DCI that includes tentative drop field.
>: The tentative drop field is set to 1.

UE drops PPW for serving cells a PPW_SET during a specific period.
>: The PPW_SET includes serving cells for which PPW is activated.
>: The specific period is from n+m to n+m+k; or
>: The specific period is determined such that the first PPW after n+m is dropped for the corresponding serving cells.

UE drops SA_intra for serving cells of a SA_intra_SET during the specific period.
>: The SA_intra_SET includes the serving cells in the same band as the specific serving cell; or
>: The SA_intra_SET includes the serving cells in the same FR as the specific serving cell.
>: The specific period is from n+m to n+m+k; or
>: The specific period is determined such that the first SA_intra after n+m is dropped for the corresponding serving cells.

UE drops SA_inter for serving cells of a SA_inter_SET of serving cells during the specific period.
>: The SA_inter_SET includes the serving cells in the same band as the specific serving cell; or
>: The SA_inter_SET includes the serving cells in the same FR as the specific serving cell.
>: The specific period is from n+m to n+m+k; or
>: The specific period is determined such that the first SA_inter after n+m is dropped for the corresponding serving cells.

UE drops MUSIM Gap for all serving cells during the specific period.
>: The specific period is from n+m to n+m+k; or
>: The specific period is determined such that the first MUSIM gap after n+m is dropped for the corresponding serving cells.

UE drops MG for serving cell of MG_SET during the specific period.
>: The specific period is from n+m to n+m+k; or
>: The specific period is determined such that the first MG after n+m is dropped for the corresponding serving cells.

UE receives a specific DCI in a specific serving cell.
>: The specific DCI is DCI that includes tentative drop field.
>: The tentative drop field is set to 0.

UE resumes PPW for serving cells of the PPW_SET.
>: The PPW_SET includes serving cells for which PPW is activated.

UE resumes SA_intra for serving cells of the SA_intra_SET.
>: The SA_intra_SET includes the serving cells in the same band as the specific serving cell; or
>: The SA_intra_SET includes the serving cells in the same FR as the specific serving cell.

UE resumes SA_inter for serving cells of the SA_inter_SET of serving cells.
>: The SA_inter_SET includes the serving cells in the same band as the specific serving cell; or
>: The SA_inter_SET includes the serving cells in the same FR as the specific serving cell.

UE resumes MG for serving cell of MG_SET.

MG/SA_xxx/PPW is resumed for the corresponding serving cells in case that MG/SA_xxx/PPW is being dropped for the corresponding serving cells.

MG/SA_xxx/PPW is resumed for the corresponding serving cells in case that tentative drop is being applied for the corresponding serving cells.

The first XXX is first XXX that occurs in the next onDuration/Active Time in case that C-DRX is applied for the serving cell (or DRX group of the serving cell).

### S100: RRCReconfiguration for Gap Requirement Configuration

### Gap Requirement Configuration

At S100, GNB transmits to UE a RRCReconfiguration message for gap requirement reporting configuration. UE performs followings:
>: if the RRCReconfiguration message includes the needForGapsConfigNR:
>>: if needForGapsConfigNR is set to setup:
>>>: consider itself to be configured to provide the measurement gap requirement information of NR target bands;
>>: else:
>>>: consider itself not to be configured to provide the measurement gap requirement information of NR target bands;
>: if the RRCReconfiguration message includes the needForGapNCSG-ConfigNR:
>>: if needForGapNCSG-ConfigNR is set to setup:
>>>: consider itself to be configured to provide the measurement gap and NCSG requirement information of NR target bands;
>>: else:
>>>: consider itself not to be configured to provide the measurement gap and NCSG requirement information of NR target bands;
>: if the RRCReconfiguration message includes the needForGapNCSG-ConfigEUTRA:
>: if needForGapNCSG-ConfigEUTRA is set to setup:
>>>: consider itself to be configured to provide the measurement gap and NCSG requirement information of E UTRA target bands;
>>: else:
>>>: consider itself not to be configured to provide the measurement gap and NCSG requirement information of E UTRA target bands;
needForGapsConfigNR-r16 SetupRelease {NeedForGapsConfigNR-r16}

The IE NeedForGapsConfigNR contains configuration related to the reporting of measurement gap requirement information.

```
  -- ASN1START
  -- TAG-NeedForGapsConfigNR-START
```

| | |
|---|---|
| NeedForGapsConfigNR-r16 ::= | SEQUENCE |
| requestedTargetBandFilterNR-r16 | SEQUENCE (SIZE (1..maxBands)) OF |
| FreqBandIndicatorNR | OPTIONAL -- Need R |
| } | |

```
  -- TAG-NeedForGapsConfigNR-STOP
  -- ASN1STOP
```

requestedTargetBandFilterNR: Indicates the target NR bands that the UE is requested to report the gap requirement information.

### S200: RRCReconfigurationComplete for Gap Requirements Reporting

At S200, UE transmits to the GNB RRCReconfigurationComplete. The message includes information on gap requirement. UE performs followings:
>>: if the RRCReconfiguration message was received via SRB1, but not within mrdc-SecondaryCellGroup or E-UTRA RRCConnectionReconfiguration or E-UTRA RRCConnectionResume:
>>>: if the UE is configured to provide the measurement gap requirement information of NR target bands:
>>>>: if the RRCReconfiguration message includes the needForGapsConfigNR; or
>>>>: if the NeedForGapsInfoNR information is changed compared to last time the UE reported this information; or
>>>>: if the RRCReconfiguration message includes the needForInterruptionConfigNR and set it to enabled; or
>>>>: if the needForInterruptionConfigNR is enabled and the NeedForInterruptionInfoNR information is changed compared to last time the UE reported this information:
>>>>>: include the NeedForGapsInfoNR and set the contents as follows:
>>>>>>: include intraFreq-needForGap and set the gap requirement information of intra-frequency measurement for each NR serving cell;
>>>>>>: if requestedTargetBandFilterNR is configured:
>>>>>>: for each supported NR band that is also included in requestedTargetBandFilterNR, include an entry in interFreq-needForGap and set the gap requirement information for that band;
>>>>>>: else:
>>>>>>>: include an entry in interFreq-needForGap and set the corresponding gap requirement information for each supported NR band;

### RRCReconfigurationComplete

The RRCReconfigurationComplete message is used to confirm the successful completion of an RRC connection reconfiguration.
Signalling radio bearer: SRB1 or SRB3
RLC-SAP: AM
Logical channel: DCCH
Direction: UE to Network
needForGapsInfoNR-r16 NeedForGapsInfoNR-r16 OPTIONAL,

### NeedForGapsInfoNR

The IE NeedForGapsInfoNR indicates whether measurement gap is required for the UE to perform SSB based measurements on an NR target band while NR-DC or NE-DC is not configured.

### NeedForGapsInfoNR Information Element

| | |
|---|---|
| -- ASN1START | |
| -- TAG-NeedForGapsInfoNR-START | |
| NeedForGapsInfoNR-r16 ::= | SEQUENCE { |
| intraFreq-needForGap-r16 | NeedForGapsIntraFreqList-r16, |
| interFreq-needForGap-r16 | NeedForGapsBandListNR-r16 |
| } | |
| NeedForGapsIntraFreqList-r16 ::= | SEQUENCE (SIZE (1.. |

maxNrofServingCells)) OF NeedForGapsIntraFreq-r16

| | |
|---|---|
| NeedForGapsBandListNR-r16 ::= | SEQUENCE (SIZE (1..maxBands)) OF |
| NeedForGapsNR-r16 | |
| NeedForGapsIntraFreq-r16 ::= | SEQUENCE { |
| servCellId-r16 | ServCellIndex, |
| gapIndicationIntra-r16 | ENUMERATED { gap, no-gap} |
| } | |
| NeedForGapsNR-r16 ::= | SEQUENCE { |
| bandNR-r16 | FreqBandIndicatorNR, |
| gapIndication-r16 | ENUMERATED { gap, no-gap} |
| } | |
| -- TAG-NeedForGapsInfoNR-STOP | |
| -- ASN1STOP | |

intraFreq-needForGap: Indicates the measurement gap requirement information for NR intra-frequency measurement.
interFreq-needForGap: Indicates the measurement gap requirement information for NR inter-frequency measurement.
servCellId: Indicates the serving cell which contains the target SSB (associated with the initial DL BWP) to be measured.
gapIndicationIntra: Indicates whether measurement gap is required for the UE to perform intra-frequency SSB based measurements on the concerned serving cell. Value gap indicates that a measurement gap is needed if any of the UE configured BWPs (except the BWP(s) configured with servingCellMO associated with NCD-SSB) do not contain the frequency domain resources of the SSB associated to the initial DL BWP (CD-SSB). Value no-gap indicates a measurement gap is not needed to measure the SSB associated to the initial DL BWP (CD-SSB) for all configured BWPs (except the BWP(s) configured with servingCellMO associated with NCD-SSB), no matter the SSB is within the configured BWP or not. This field shall be set to ‘no-gap’ for the serving cell(s) belonging to the corresponding band(s) where bwpOperationMeasWithoutInterrupt-r18 is supported by the UE.
bandNR: Indicates the NR target band to be measured.
gapIndication: Indicates whether measurement gap is required for the UE to perform SSB based measurements on the concerned NR target band while NR-DC or NE-DC is not configured. The UE determines this information based on the resultant configuration of the RRCReconfiguration or RRCResume message that triggers this response. Value gap indicates that a measurement gap is needed, value no-gap indicates a measurement gap is not needed.

### S300: RRCReconfiguration for Gap Configuration

At S300, based on gap requirement reporting, GNB determines to configure the UE with various gaps. GNB transmits to the UE RRCReconfiguration message that includes configuration information of various gaps. MeasGapConfig includes set of parameters for gap configuration.

### Gap Configuration

### MeasGapConfig

The IE MeasGapConfig specifies the measurement gap configuration and controls setup/release of measurement gaps.

### MeasGapConfig Information Element

| | |
|---|---|
| -- ASN1START | |
| -- TAG-MEASGAPCONFIG-START | |
| MeasGapConfig ::= | SEQUENCE { |
| gapFR2 | SetupRelease { GapConfig } |
| OPTIONAL, -- Need M | |
| ..., | |
| [[ | |
| gapFR1 | SetupRelease { GapConfig } |
| OPTIONAL, -- Need M | |
| gapUE | SetupRelease { GapConfig } |
| OPTIONAL -- Need M | |
| ]], | |
| [[ | |
| gap ToAddModList-r17 | SEQUENCE (SIZE (1..maxNrofGapId-r17)) OF |

GapConfig-r17 OPTIONAL, -- Need N

| | |
|---|---|
| gapToReleaseList-r17 | SEQUENCE (SIZE (1..maxNrofGapId-r17)) OF |

MeasGapId-r17 OPTIONAL, -- Need N

| | |
|---|---|
| posMeasGapPreConfigToAddModList-r17 | |
| PosMeasGapPreConfigToAddModList-r17 | OPTIONAL, -- |
| Need N | |
| posMeasGapPreConfigToReleaseList-r17 | |
| PosMeasGapPreConfigToReleaseList-r17 | OPTIONAL -- |
| Need N | |
| ]] | |
| } | |
| GapConfig ::= | SEQUENCE { |
| gapOffset | INTEGER (0..159), |
| mgl | ENUMERATED {ms1dot5, ms3, ms3dot5, ms4, |
| ms5dot5, ms6}, | |
| mgrp | ENUMERATED {ms20, ms40, ms80, ms160}, |
| mgta | ENUMERATED {ms0, ms0dot25, ms0dot5}, |
| ..., | |
| [[ | |
| refServCellIndicator | ENUMERATED {pCell, pSCell, mcg-FR2} |
| OPTIONAL -- Cond NEDCorNRDC | |
| ]], | |
| [[ | |
| refFR2-ServCellAsyncCA-r17 | ServCellIndex |
| OPTIONAL, -- Cond AsyncCA | |
| mgl-r16 | ENUMERATED {ms10, ms20} |
| OPTIONAL, -- Cond PRS | |
| ]] | |
| } | |
| GapConfig-r17 ::= | SEQUENCE { |
| measGapId-r17 | MeasGapId-r17, |
| gapType-r17 | ENUMERATED {perUE, perFR1, perFR2}, |
| gapOffset-r17 | INTEGER (0..159), |
| mgl-r17 | ENUMERATED {ms1, ms1dot5, ms2, ms3, |
| ms3dot5, ms4, ms5, ms5dot, ms6, ms10, ms20}, | |
| mgrp-r17 | ENUMERATED {ms20, ms40, ms80, ms160}, |
| mgta-r17 | ENUMERATED {ms0, ms0dot25, ms0dot5 |
| ms0dot75}, | |
| refServCell Indicator-r17 | ENUMERATED {pCell, pSCell, mcg-FR2} |
| OPTIONAL, -- Cond NEDCorNRDC | |
| refFR2-ServCellAsyncCA-r17 | ServCellIndex |
| OPTIONAL, -- Cond AsyncCA | |
| preConfigInd-r17 | ENUMERATED {true} |
| OPTIONAL, -- Need R | |
| ncsgInd-r17 | ENUMERATED {true} |
| OPTIONAL, -- Need R | |
| gapAssociationPRS-r17 | ENUMERATED {true} |
| OPTIONAL, -- Need R | |
| gapSharing-r17 | MeasGapSharingScheme |
| OPTIONAL, -- Need R | |
| gapPriority-r17 | GapPriority-r17 |
| OPTIONAL, -- Need R | |
| ... | |
| } | |

```
  PosMeasGapPreConfigToAddModList-r17  ::=  SEQUENCE  (SIZE
(1..maxNrofPreConfigPosGapId-r17)) OF PosGapConfig-r17
  PosMeasGapPreConfigToReleaseList-r17  ::= SEQUENCE  (SIZE
(1..maxNrofPreConfigPosGapId-r17)) OF MeasPosPreConfigGapId-r17
```

| | |
|---|---|
| PosGapConfig-r17 ::= | SEQUENCE { |
| measPosPreConfigGapId-r17 | MeasPosPreConfigGapId-r17, |
| gapOffset-r17 | INTEGER (0..159), |
| mgl-r17 | ENUMERATED {ms1dot5, ms3, ms3dot5, ms4, |
| ms5dot, ms6, ms10, ms20}, | |
| mgrp-r17 | ENUMERATED {ms20, ms40, ms80, ms160}, |
| mgta-r17 | ENUMERATED {ms0, ms0dot25, ms0dot5}, |
| gapType-r17 | ENUMERATED {perUE, perFR1, perFR2}, |
| ... | |
| } | |

```
  MeasPosPreConfigGapId-r17 ::= INTEGER (1..maxNrofPreConfigPosGapId-r17)
  -- TAG-MEASGAPCONFIG-STOP
  -- ASN1STOP
```

gapAssociationPRS: Indicates that PRS measurement is associated with this measurement gap. The network only includes this field for one per-UE gap or for one per-FR gap. If concurrent gap (i.e. one of the gap combination as defined in Table 9.1.8-1 in TS 38.133) is configured and no gap is configured with this field, the PRS measurement is associated with the gap configured via GapConfig (without suffix), if available. If both per-UE gap and per-FR gap are configured via GapConfig and/or GapConfig-r17, the PRS measurement is always associated with the per-UE gap.
gapFR1: Indicates measurement gap configuration that applies to FR1 only. In (NG) EN-DC, gapFR1 cannot be set up by NR RRC (i.e. only LTE RRC can configure FR1 measurement gap). In NE-DC, gapFR1 can only be set up by NR RRC (i.e. LTE RRC cannot configure FR1 gap). In NR-DC, gapFR1 can only be set up in the measConfig associated with MCG. gapFR1 can not be configured together with gapUE. The applicability of the FR1 measurement gap is according to Table 9.1.2-2 and Table 9.1.2-3 in TS 38.133.
gapFR2: Indicates measurement gap configuration applies to FR2 only. In (NG) EN-DC or NE-DC, gapFR2 can only be set up by NR RRC (i.e. LTE RRC cannot configure FR2 gap). In NR-DC, gapFR2 can only be set up in the measConfig associated with MCG. gapFR2 cannot be configured together with gapUE. The applicability of the FR2 measurement gap is according to Table 9.1.2-2 and Table 9.1.2-3 in TS 38.133.
gapOffset: Value gapOffset is the gap offset of the gap pattern with MGRP indicated in the field mgrp. The value range is from 0 to mgrp-1. If ncsgInd-r17 is present, this offset value refers to the starting point of VIL1 (the visible interruption length before the ML).
gapPriority: Indicates the priority of this measurement gap (see TS 38.133). Value 1 indicates highest priority, value 2 indicates second level priority, and so on.
gapSharing: Indicates the measurement gap sharing scheme that applies to this GapConfig. For applicability of the different gap sharing schemes, see TS 38.133. Value scheme00 corresponds to scheme “00”, value scheme01 corresponds to scheme “01”, and so on.
gapToAddModList: A list of of measurement gap configuration to be added or modified. If more than one measurement gap is configured (i.e. concurrent measurement gap as specified in TS 38.133, clause 9.1.8 for TN or clause 9.1C.8 for NTN), the maximum number of configured measurement gap is limited by the gap combinations defined in Table 9.1.8-1 in TS 38.133 for TN. For NTN the maximum number of configured measurement gap is limited by UE capability indicated in parallelMeasurementGap. In this version of the specification, the network configures this field only in NR standalone. This field is used only for a UE that supports pre-configured measurement gap, concurrent measurement gap, or NCSG. In this version of the specification, the network does not configure concurrent measurement gap together with preconfigured measurement gap for positioning. For the UE not supporting the capability of musim-GapPriorityPreference, the network does not configure concurrent measurement gap together with MUSIM gap.
gapToReleaseList: A list of measurement gap configuration to be released.
gapType: Indicates the type of this measurement gap. Value perUE indicates that it is a per UE measurement gap, value perFR1 indicates that it is an FR1 measurement gap, and value perFR2 indicates that it is an FR2 measurement gap.
gapUE: Indicates measurement gap configuration that applies to all frequencies (FR1 and FR2). In (NG) EN-DC, gapUE cannot be set up by NR RRC (i.e. only LTE RRC can configure per UE measurement gap). In NE-DC, gapUE can only be set up by NR RRC (i.e. LTE RRC cannot configure per UE gap). In NR-DC, gapUE can only be set up in the measConfig associated with MCG. If gapUE is configured, then neither gapFR1 nor gapFR2 can be configured. For TN, the applicability of the per UE measurement gap is according to Table 9.1.2-2 and Table 9.1.2-3 for non-RedCap UEs, and Table 9.1A.2-2 for RedCap UEs in TS 38.133. For NTN, the applicability of per UE measurement gap is according to subclause 9.1C.2 in TS 38.133.
measGapId: The ID of this measurement gap configuration.
Mgl: Value mgl is the measurement gap length in ms of the measurement gap. If ncsgInd-r17 is not present, the measurement gap length is according to Table 9.1.2-1 for non-RedCap UEs in TN, Table 9.1A.2-1 for RedCap UEs in TN, and Table 9.1C.2-1 for NTN in TS 38.133. If ncsgInd-r17 is present, this field indicates the measurement length (ML) in NCSG pattern and is configured according to Table 9.1.9.3-1 in TS 38.133. Value ms1dot5 corresponds to 1.5 ms, ms3 corresponds to 3 ms and so on. If mgl-r16 is present, UE shall ignore the mgl (without suffix). Value ms1, ms2, and ms5 can only be configured if ncsgInd is present.
Mgrp: If ncsgInd-r17 is not present, the mgrp field indicates the measurement gap repetition period in (ms) of the measurement gap according to Table 9.1.2-1 for non-RedCap UEs in TN, Table 9.1A.2-1 for RedCap UEs in TN, and Table 9.1C.2-1 for NTN in TS 38.133. If ncsgInd-r17 is present, the mgrp field indicates the Visible Interruption Repetition Period (VIRP) of NCSG pattern and is configured according to Table 9.1.9.3-1 in TS 38.133.
Mgta: Value mgta is the measurement gap timing advance in ms. The applicability of the measurement gap timing advance is according to clause 9.1.2 for non-RedCap UEs in TN, clause 9.1A.2 for RedCap UEs in TN, and clause 9.1C.2 for NTN of TS 38.133, or according to clause 9.1.9 of TS 38.133 if ncsgInd is present. Value ms0 corresponds to 0 ms, ms0dot25 corresponds to 0.25 ms, ms0dot5 corresponds to 0.5 ms and ms0dot75 corresponds to 0.75 ms. For FR2, the network only configures 0 ms and 0.25 ms if ncsgInd is not present. If ncsgInd is present, the network only configures Oms for per-UE NCSG and FR1 NCSG and only configures 0 ms or 0.75 ms for FR2 NCSG. Value ms0dot75 can only be configured if ncsgInd is present.
ncsgInd: Indicates that the measurement gap is a NCSG as specified in 38.133.
posMeasGapPreConfigToAddModList: List of preconfigured measurement gap for positioning to add and/or modify. All the gaps configured are associated with the measurement of PRS for RSTD, UE-RxTx Time Difference, PRS-RSRP and PRS-RSRPP as defined in TS 38.215 [9]. In this version of the specification, the network does not configure preconfigured measurement gap for positioning together with concurrent measurement gap or MUSIM gap.
posMeasGapPreConfigToReleaseList: List of preconfigured measurement gap for positioning to release.
preConfigInd: Indicates whether the measurement gap is a pre-configured measurement gap.
refFR2ServCellAsyncCA: Indicates the FR2 serving cell identifier whose SFN and subframe is used for FR2 gap calculation for this gap pattern with asynchronous CA involving FR2 carrier(s).
refServCellIndicator: Indicates the serving cell whose SFN and subframe are used for gap calculation for this gap pattern. Value pCell corresponds to the PCell, pSCell corresponds to the PSCell, and mcg-FR2 corresponds to a serving cell on FR2 frequency in MCG.

### MUSIM-GapConfig

The IE MUSIM-GapConfig specifies the MUSIM gap configuration and controls setup/release of MUSIM gaps.

### MUSIM-GapConfig Information Element

```
  -- ASN1START
  -- TAG-MUSIM-GAPCONFIG-START
```

| | |
|---|---|
| MUSIM-GapConfig-r17 ::= | SEQUENCE { |
| musim-GapToReleaseList-r17 | SEQUENCE (SIZE (1..3)) OF |

MUSIM-GapId-r17 OPTIONAL, -- Need N

| | |
|---|---|
| musim-GapToAddModList-r17 | SEQUENCE (SIZE (1..3)) OF |

MUSIM-Gap-r17 OPTIONAL, -- Need N

| | |
|---|---|
| musim-AperiodicGap-r17 | MUSIM-GapInfo-r17 |
| OPTIONAL, -- Need N | |
| ..., | |
| [[ | |
| musim-GapToAddModListExt-v1820 | SEQUENCE (SIZE (1..3)) OF |

MUSIM-GapExt-v1820 OPTIONAL, -- Need N

| | |
|---|---|
| musim-GapKeep-r18 | ENUMERATED {true} |
| OPTIONAL -- Need N | |
| ]] | |
| } | |
| MUSIM-Gap-r17 ::= | SEQUENCE { |
| musim-GapId-r17 | MUSIM-GapId-r17, |
| musim-GapInfo-r17 | MUSIM-GapInfo-r17 |
| } | |
| MUSIM-GapExt-v1820 ::= | SEQUENCE { |
| gapPriority-r18 | GapPriority-r17 |
| } | |

```
  -- TAG-MUSIM-GAPCONFIG-STOP
  -- ASN1STOP
```

musim-AperiodicGap: Indicates the MUSIM aperiodic gap as specified in TS 38.133 clause 9.1.10. If UE indicates the musim-Starting-SFN-AndSubframe when requesting aperiodic gap the network can only configure the aperiodic gap with the same start point or no aperiodic gap. If the field musim-Starting-SFN-AndSubframe is absent for aperiodic gap, network can configure any timing as the starting point for aperiodic gap or configure no aperiodic gap.
musim-GapInfo: Indicates the values for musim-GapLength and musim-GapRepetitionAndOffset. When network provides periodic gap, network always signals the musim-GapLength and musim-GapRepetitionAndOffset as indicated by the UE's preferred MUSIM gap configuration.
musim-GapKeep: Indicates the UE is allowed to use “keep solution” for colliding MUSIM periodic/aperiodic gaps. If “keep solution” is not granted, collisions between MUSIM periodic gaps are resolved based on the assigned MUSIM gap priorities as specified in TS 38.133.
musim-GapToAddModListExt: Indicates the priority of MUSIM periodic gap(s). If the network includes musim-GapToAddModListExt-v1820, it includes the same number of entries, and listed in the same order, as in musim-GapToAddModList-r17. For the priority of MUSIM aperiodic gap, the MUSIM aperiodic gap is always kept (not dropped) from UE perspective in case of collisions with other gaps (i.e. all gaps including MUSIM gaps, etc).
musim-GapToAddModList: List of MUSIM periodic gap patterns to add or modify.
musim-GapToReleaseList: List of MUSIM periodic gap patterns to release.

### MUSIM-GapInfo

The IE MUSIM-GapInfo is used to indicate MUSIM gap parameters.

### MUSIM-GapInfo Information Element

```
  -- ASN1START
  -- TAG-MUSIM-GAPINFO-START
```

| | |
|---|---|
| MUSIM-GapInfo-r17 ::= | SEQUENCE { |
| musim-Starting-SFN-AndSubframe-r17 | MUSIM-Starting-SFN-AndSubframe-r17 |
| OPTIONAL, -- Cond aperiodic | |
| musim-GapLength-r17 | ENUMERATED {ms3, ms4, ms6, ms10, |
| ms20} OPTIONAL, -- Cond gapSetup | |
| musim-GapRepetitionAndOffset-r17 | CHOICE { |
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-r17 | INTEGER (0..5119), |
| ... | |
| } | |
| OPTIONAL -- Cond periodic | |
| } | |

MUSIM-Starting-SFN-AndSubframe-r17 ::= SEQUENCE {

| | |
|---|---|
| starting-SFN-r17 | INTEGER (0..1023), |
| startingSubframe-r17 | INTEGER (0..9) |
| } | |

```
  -- TAG-MUSIM-GAPINFO-STOP
  -- ASN1STOP
```

musim-GapLength: Indicates the length of the UE's MUSIM gap as specified in TS 38.133 clause 9.1.10. This field is mandatory present for both periodic gap and aperiodic gap preference indication.
musim-GapRepetitionAndOffset: Indicates the gap repetition period in ms and gap offset in number of subframes for the periodic MUSIM gap as specified in TS 38.133 clause 9.1.10. This field is mandatory present for the periodic MUSIM gap preference indication.
musim-Starting-SFN-AndSubframe: Indicates gap starting position for the aperiodic MUSIM gap. This field is optionally present for the aperiodic MUSIM gap preference indication.
starting-SFN: Indicates gap starting SFN number for the aperiodic MUSIM gap.
startingSubframe: Indicates gap starting subframe number for the aperiodic MUSIM gap.

The IE DL-PPW-PreConfig provides configuration for a measurement window where a UE is expected to measure the DL PRS, if it is inside the active DL BWP and with the same numerology as the active DL BWP. Based upon the indication received in the configuration, the UE identifies whether the DL PRS priority is higher than that of the other DL signals or channels and accordingly determines, for example, the UE is expected to measure the DL PRS and is not expected to receive other DL signals and channels.

### DL-PPW-PreConfig Information Element

| | |
|---|---|
| -- ASN1START | |
| -- TAG-DL-PPW-PRECONFIG-START | |
| DL-PPW-PreConfig-r17 ::= SEQUENCE | |
| dl-PPW-ID-r17 | DL-PPW-ID-r17, |
| dl-PPW-Periodicity AndStartSlot-r17 | DL-PPW-PeriodicityAndStartSlot-r17, |
| length-r17 | INTEGER (1..160), |
| type-r17 | ENUMERATED {type1A, type1B, type2} |
| OPTIONAL, -- Cond MultiType | |
| priority-r17 | ENUMERATED {st1, st2, st3} |

OPTIONAL -- Cond MultiState
}
DL-PPW-ID-r17 ::= INTEGER (0..maxNrofPPW-ID-1-r17)
DL-PPW-Periodicity AndStartSlot-r17 ::= CHOICE {

| | |
|---|---|
| scs15 | CHOICE { |
| n4 | INTEGER (0..3), |
| n5 | INTEGER (0..4), |
| n8 | INTEGER (0..7), |
| n10 | INTEGER (0..9), |
| n16 | INTEGER (0..15), |
| n20 | INTEGER (0..19), |
| n32 | INTEGER (0..31), |
| n40 | INTEGER (0..39), |
| n64 | INTEGER (0..63), |
| n80 | INTEGER (0..79), |
| n160 | INTEGER (0..159), |
| n320 | INTEGER (0..319), |
| n640 | INTEGER (0..639), |
| n1280 | INTEGER (0..1279), |
| n2560 | INTEGER (0..2559), |
| n5120 | INTEGER (0..5119), |
| n10240 | INTEGER (0..10239), |
| ... | |
| }, | |
| scs30 | CHOICE { |
| n8 | INTEGER (0..7), |
| n10 | INTEGER (0..9), |
| n16 | INTEGER (0..15), |
| n20 | INTEGER (0..19), |
| n32 | INTEGER (0..31), |
| n40 | INTEGER (0..39), |
| n64 | INTEGER (0..63), |
| n80 | INTEGER (0..79), |
| n128 | INTEGER (0..127), |
| n160 | INTEGER (0..159), |
| n320 | INTEGER (0..319), |
| n640 | INTEGER (0..639), |
| n1280 | INTEGER (0..1279), |
| n2560 | INTEGER (0..2559), |
| n5120 | INTEGER (0..5119), |
| n10240 | INTEGER (0..10239), |
| n20480 | INTEGER (0..20479), |
| ... | |
| }, | |
| scs60 | CHOICE { |
| n16 | INTEGER (0..15), |
| n20 | INTEGER (0..19), |
| n32 | INTEGER (0..31), |
| n40 | INTEGER (0..39), |
| n64 | INTEGER (0..63), |
| n80 | INTEGER (0..79), |
| n128 | INTEGER (0..127), |
| n160 | INTEGER (0..159), |
| n256 | INTEGER (0..255), |
| n320 | INTEGER (0..319), |
| n640 | INTEGER (0..639), |
| n1280 | INTEGER (0..1279), |
| n2560 | INTEGER (0..2559), |
| n5120 | INTEGER (0..5119), |
| n10240 | INTEGER (0..10239), |
| n20480 | INTEGER (0..20479), |
| n40960 | INTEGER (0..40959), |
| ... | |
| }, | |
| scs120 | CHOICE { |
| n32 | INTEGER (0..31), |
| n40 | INTEGER (0..39), |
| n64 | INTEGER (0..63), |
| n80 | INTEGER (0..79), |
| n128 | INTEGER (0..127), |
| n160 | INTEGER (0..159), |
| n256 | INTEGER (0..255), |
| n320 | INTEGER (0..319), |
| n512 | INTEGER (0..511), |
| n640 | INTEGER (0..639), |
| n1280 | INTEGER (0..1279), |
| n2560 | INTEGER (0..2559), |
| n5120 | INTEGER (0..5119), |
| n10240 | INTEGER (0..10239), |
| n20480 | INTEGER (0..20479), |
| n40960 | INTEGER (0..40959), |
| n81920 | INTEGER (0..81919), |
| ... | |
| }, | |
| ... | |
| } | |
| -- TAG-DL-PPW-PRECONFIG-STOP | |
| -- ASNISTOP | |

dl-PPW-ID: Indicates the pre-configured ID for DL-PRS processing window configuration.
dl-PPW-PeriodicityAndStartSlot: Indicates the periodicity in slots and the offset of the starting slot with respect to SFN #0 slot #0 of the serving cell where the DL-PRS processing window is configured.
Length: Indicates the length of DL-PRS processing window in slots. Value 1 indicates length of one slot, value 2 indicates length of two slots and so on.
Priority: Indicates the priority between PDCCH/PDSCH/CSI-RS and PRS as specified in TS 38.214 [19].
Type: Indicates the DL-PRS processing window type as specified in TS 38.214 [19].

UE performs following to configure measurement gaps based on MeasGapConfig

### Measurement Gap Configuration

The UE shall:
>: if gapFR1 is set to setup:
>>: if an FR1 measurement gap configuration configured by gapFR1 is already setup, release the FR1 measurement gap configuration;
>>: setup the FR1 measurement gap configuration indicated by the gapFR1 in accordance with the received gapOffset, i.e., the first subframe of each gap occurs at an SFN and subframe meeting the following condition:

SFN mod T=FLOOR(gapOffset/10);
subframe=gapOffset mod 10;
with T=MGRP/10 as defined in TS 38.133;
>>: apply the specified timing advance mgta to the gap occurrences calculated above (i.e. the UE starts the measurement mgta ms before the gap subframe occurrences);
>: else if gapFR1 is set to release:
>>: release the FR1 measurement gap configuration configured by gapFR1;
>: if gapFR2 is set to setup:
>>: if an FR2 measurement gap configuration configured by gapFR2 is already setup, release the FR2 measurement gap configuration;
>>: setup the FR2 measurement gap configuration indicated by the gapFR2 in accordance with the received gapOffset, i.e., the first subframe of each gap occurs at an SFN and subframe meeting the following condition:

SFN mod T=FLOOR(gapOffset/10);
subframe=gapOffset mod 10;
with T=MGRP/10 as defined in TS 38.133;
>>: apply the specified timing advance mgta to the gap occurrences calculated above (i.e. the UE starts the measurement mgta ms before the gap subframe occurrences);
>: else if gapFR2 is set to release:
>>: release the FR2 measurement gap configuration configured by gapFR2;
>: if gapUE is set to setup:
>>: if a per UE measurement gap configuration configured by gapUE is already setup, release the per UE measurement gap configuration;
>>: setup the per UE measurement gap configuration indicated by the gapUE in accordance with the received gapOffset, i.e., the first subframe of each gap occurs at an SFN and subframe meeting the following condition:

SFN mod T=FLOOR(gapOffset/10);
subframe=gapOffset mod 10;
with T=MGRP/10 as defined in TS 38.133;
>>: apply the specified timing advance mgta to the gap occurrences calculated above (i.e. the UE starts the measurement mgta ms before the gap subframe occurrences);
>: else if gapUE is set to release:
>>: release the per UE measurement gap configuration configured by gapUE.
>: for each measGapId included in the received gapToReleaseList:
>>: release the measurement gap configuration associated with the measGapId;
>: for each measPosPreConfigGapId included in the received posMeasGapPreConfigToReleaseList:
>>: release the measurement gap configuration associated with the measPosPreConfigGapId;
>: for each GapConfig received in gapToAddModList:
>>: setup measurement gap configuration indicated by the GapConfig in accordance with the received gapOffset, i.e., the first subframe of each gap occurs at an SFN and subframe meeting the following condition:

SFN mod T=FLOOR(gapOffset/10);
subframe=gapOffset mod 10;
with T=MGRP/10 as defined in TS 38.133;
>>: apply the specified timing advance mgta to the gap occurrences calculated above (i.e. the UE starts the measurement mgta ms before the gap subframe occurrences);
>>: apply the measurement gap as per UE measurement gap, FR1 measurement gap, or FR2 measurement gap according to the gapType indicated by the GapConfig;
>>: associate the measurement gap with the measGapId indicated by the GapConfig;
>>: if gapSharing in the GapConfig is present:
>>>: setup the gap sharing configuration for the measurement gap in accordance with the received gapSharing as defined in TS 38.133;
>>: else:
>>>: release the gap sharing configuration (if configured) for the measurement gap;
>: for each PosGapConfig received in PosMeasGapPreConfigToAddModList:
>>: if a measurement gap configuration associated with the measPosPreConfigGapId indicated by the PosGapConfig is already setup:
>>>: release the measurement gap configuration;
>>: setup measurement gap configuration indicated by the PosGapConfig in accordance with the received gapOffset, i.e., the first subframe of each gap occurs at an SFN and subframe meeting the following condition:

SFN mod T=FLOOR(gapOffset/10);
subframe=gapOffset mod 10;
with T=MGRP/10 as defined in TS 38.133;
>>: apply the specified timing advance mgta to the gap occurrences calculated above (i.e. the UE starts the measurement mgta ms before the gap subframe occurrences);
>>: configure the measurement gap as indicated by gapType;
>: for each FR1, FR2, and per UE measurement gap that is setup:
>>: if the measurement gap is configured by GapConfig and preConfigInd-r17 in the corresponding GapConfig is present:
>>>: determine whether the measurement gap is activated or not;
>>: else if the measurement gap is configured by PosGapConfig:
>>>: consider the measurement gap to be deactivated;
>>: else:
>>>: consider the measurement gap to be activated.

For FR2 gap configuration with synchronous CA, for the UE in NE-DC or NR-DC, the SFN and subframe of the serving cell indicated by the refServCellIndicator is used in the gap calculation. Otherwise, the SFN and subframe of a serving cell on FR2 frequency is used in the gap calculation

For FR1 gap or per UE gap configuration, for the UE in NE-DC or NR-DC, the SFN and subframe of the serving cell indicated by the refServCellIndicator in is used in the gap calculation. Otherwise, the SFN and subframe of the PCell is used in the gap calculation.

For FR2 gap configuration with asynchronous CA, for the UE in NE-DC or NR-DC, the SFN and subframe of the serving cell indicated by the refServCellIndicator and refFR2ServCellAsyncCA is used in the gap calculation. Otherwise, the SFN and subframe of a serving cell on FR2 frequency indicated by the refFR2ServCellAsyncCA is used in the gap calculation.

### MUSIM Gap Configuration

The UE shall:
>: if musim-GapConfig is set to setup:
>>: for each musim-GapId included in the received musim-GapToReleaseList:
>>>: release the periodic MUSIM gap configuration associated with the musim-GapId;
>>: for each MUSIM-Gap included in the received musim-GapToAddModList:
>>>: setup periodic MUSIM gap configuration indicated by the MUSIM-Gap in accordance with the received musim-GapRepetitionAndOffset (providing musim-GapRepetition and Offset value for the following condition) i.e. the first subframe of each periodic MUSIM gap occurs at an SFN and subframe of the NR PCell meeting the following condition:

SFN mod T=FLOOR(Offset/10);
subframe=Offset mod 10;
with T=musim-GapRepetition/10;
>>>: set the MUSIM gap priority configuration indicated by musim-GapToAddModListExt, if configured, for each periodic MUSIM gap;
NOTE: If network does not configure the relative priorities among MUSIM gaps as indicated by the UE, UE behaviour is not specified.
>>: if musim-AperiodicGap is included:
>>>: setup aperiodic MUSIM gap configuration indicated by the musim-AperiodicGap in accordance with the received musim-Starting-SFN-AndSubframe, i.e. the first subframe of aperiodic MUSIM gap occurs at an SFN and subframe of the NR PCell meeting the following condition:

SFN=starting-SFN;
subframe=startingSubframe;
>>: keep all colliding MUSIM gaps as specified in TS 38.133, if musim-GapKeep is configured;
>: else if musim-GapConfig is set to release:
>>: release the MUSIM gap configuration.

### S400: RRCReconfiguration

GNB may determine to reconfigure UE so that XR traffic can be better handled. GNB transmits to the UE RRCReconfiguration message. The message contains various configuration information explained below.

### Configuration for XR

GNB can establish DRBs for XR traffic. The DRB for XR traffic may be configured with delay-sensitive configurations, such as shorter discard timer value. GNB can reconfigure MAC entity to report delay sensitive traffic. If gap is configured for the UE, GNB may configure UE to allow tentative drop of gap (or scheduling restriction).

### Tentative-Drop-Of-Gap/Scheduling-Restriction Configuration

GNB may control tentative-drop-of-gap (TDG) or tentative-drop-of-restriction (TDR). TDG/TDR is instructed by a specific bit in DCI format 0_1/0_2/1_1/1_2. If tentativeDrop is configured, DCI formats may contains following fields.

### Format 0_1

DCI format 0_1 is used for the scheduling of one or multiple PUSCH in one cell, or indicating CG downlink feedback information (CG-DFI) to a UE.

The following information is transmitted by means of the DCI format 0_1 with CRC scrambled by C-RNTI or CS-RNTI or SP-CSI-RNTI or MCS-C-RNTI:
>: Identifier for DCI formats—1 bit
>>: The value of this bit field is always set to 0, indicating an UL DCI format
>: Carrier indicator—0 or 3 bits, as defined in Clause 10.1 of [5, TS38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
>: UL/SUL indicator—0 bit for UEs not configured with supplementaryUplink in ServingCellConfig in the cell or UEs configured with supplementaryUplink in ServingCellConfig in the cell but only one carrier in the cell is configured for PUSCH transmission; otherwise, 1 bit as defined in Table 7.3.1.1.1-1.
>: Bandwidth part indicator—0, 1 or 2 bits as determined by the number of UL BWPs configured by higher layers, excluding the initial UL bandwidth part.
>: Frequency domain resource assignment—number of bits determined by the size of the active UL bandwidth part:
>: Time domain resource assignment—0, 1, 2, 3, 4, 5, or 6 bits
>: Frequency hopping flag—0 or 1 bit:
>: Tentative Drop—0 bit for UEs not configured with tentativeDrop in the cell (in the corresponding ServingCellConfigCommon); 1 bit for UEs configured with tentativeDrop in the cell.
>: Transform precoder indicator—0 or 1 bit
>: HARQ process number—5 bits if higher layer parameter harq-ProcessNumberSizeDCI-0-1 is configured; otherwise 4 bits

### Format 0_2

DCI format 0_2 is used for the scheduling of PUSCH in one cell.

The following information is transmitted by means of the DCI format 0_2 with CRC scrambled by C-RNTI or CS-RNTI or SP-CSI-RNTI or MCS-C-RNTI:
>: Identifier for DCI formats—1 bit
>>: The value of this bit field is always set to 0, indicating an UL DCI format
>: Carrier indicator—0, 1, 2 or 3 bits determined by higher layer parameter carrierIndicatorSizeDCI-0-2, as defined in Clause 10.1 of [5, TS38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
>: UL/SUL indicator—0 bit for UEs not configured with supplementaryUplink in ServingCellConfig in the cell or UEs configured with supplementaryUplink in ServingCellConfig in the cell but only one carrier in the cell is configured for PUSCH transmission; otherwise, 1 bit as defined in Table 7.3.1.1.1-1.
>: Bandwidth part indicator—0, 1 or 2 bits as determined by the number of UL BWPs
>: Frequency domain resource assignment
>: Time domain resource assignment—0, 1, 2, 3, 4, 5 or 6 bits
>: Frequency hopping flag—0 or 1 bit:
>: Tentative Drop—0 bit for UEs not configured with tentativeDrop in the cell; 1 bit for UEs configured with tentativeDrop in the cell.
>: Modulation and coding scheme—5 bits as defined in Clause 6.1.4.1 of [6, TS 38.214]
>: New data indicator—1 bit
>: Redundancy version—0, 1 or 2 bits determined by higher layer parameter numberOfBitsForRV-DCI-0-2
>: Transform precoder indicator—0 or 1 bit
>: HARQ process number
>: TPC command for scheduled PUSCH-2 bits as defined in Clause 7.1.1 of [5, TS38.213]
>: SRS resource set indicator—0 or 2 bits
>: Precoding information and number of layers
>: Second Precoding information
>: Antenna ports
>: SRS request
>: UL-SCH indicator—1 bit. A value of “1” indicates UL-SCH shall be transmitted on the PUSCH and a value of “0” indicates UL-SCH shall not be transmitted on the PUSCH. If a UE does not support triggering SRS only in DCI, except for DCI format 0_2 with CRC scrambled by SP-CSI-RNTI, the UE is not expected to receive a DCI format 0_2 with UL-SCH indicator of “0” and CSI request of all zero(s). If a UE supports triggering SRS only in DCI, except for DCI format 0_2 with CRC scrambled by SP-CSI-RNTI, the UE is not expected to receive a DCI format 0_2 with UL-SCH indicator of “0”, CSI request of all zero(s) and SRS request of all zero(s).

### Format 1_1

DCI format 1_1 is used for the scheduling of one or multiple PDSCH in one cell.

The following information is transmitted by means of the DCI format 1_1 with CRC scrambled by C-RNTI or CS-RNTI or MCS-C-RNTI:
>: Identifier for DCI formats—1 bits

The value of this bit field is always set to 1, indicating a DL DCI format
>: Carrier indicator—0 or 3 bits as defined in Clause 10.1 of [5, TS 38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
>: Bandwidth part indicator—0, 1 or 2 bits
>: Frequency domain resource assignment
>: Time domain resource assignment—0, 1, 2, 3, 4, 5 or 6 bits
>: VRB-to-PRB mapping—0 or 1 bit:
>: PRB bundling size indicator—0 bit if the higher layer parameter prb-BundlingType is not configured or is set to ‘staticBundling’, or 1 bit if the higher layer parameter prb-BundlingType is set to ‘dynamicBundling’ according to Clause 5.1.2.3 of [6, TS 38.214].
>: Rate matching indicator—0, 1, or 2 bits according to higher layer parameters rateMatchPatternGroup1 and rateMatchPatternGroup2, where the MSB is used to indicate rateMatchPatternGroup1 and the LSB is used to indicate rateMatchPatternGroup2 when there are two groups.
>: ZP CSI-RS trigger—0, 1, or 2 bits as defined in Clause 5.1.4.2 of [6, TS 38.214]. The bitwidth for this field is determined as ┌log₂(n_{ZP}+1)┐ bits, where n_{ZP} is the number of aperiodic ZP CSI-RS resource sets configured by higher layer.
>: Tentative Drop—0 bit for UEs not configured with tentativeDrop in the cell; 1 bit for UEs configured with tentativeDrop in the cell.

### Format 1_2

DCI format 1_2 is used for the scheduling of PDSCH in one cell.

The following information is transmitted by means of the DCI format 1_2 with CRC scrambled by C-RNTI or CS-RNTI or MCS-C-RNTI:
>: Identifier for DCI formats—1 bits

The value of this bit field is always set to 1, indicating a DL DCI format.
>: Carrier indicator—0, 1, 2 or 3 bits determined by higher layer parameter carrierIndicatorSizeDCI-1-2, as defined in Clause 10.1 of [5, TS38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
>: Bandwidth part indicator—0, 1 or 2 bits
>: Frequency domain resource assignment
>: Time domain resource assignment-0, 1, 2, 3, or 4 bits
>: VRB-to-PRB mapping—0 or 1 bit:
>: Tentative Drop—0 bit for UEs not configured with tentativeDrop in the cell; 1 bit for UEs configured with tentativeDrop in the cell
>: PRB bundling size indicator—0 bit if the higher layer parameter prb-BundlingTypeDCI-1-2 is not configured or is set to ‘static’, or 1 bit if the higher layer parameter prb-BundlingTypeDCI-1-2 is set to ‘dynamic’ according to Clause 5.1.2.3 of [6, TS 38.214].
>: Rate matching indicator—0, 1, or 2 bits according to higher layer parameters rateMatchPatternGroup1DCI-1-2 and rateMatchPatternGroup2DCI-1-2, where the MSB is used to indicate rateMatchPatternGroup1DCI-1-2 and the LSB is used to indicate rateMatchPatternGroup2DCI-1-2 when there are two groups.
>: ZP CSI-RS trigger-0, 1, or 2 bits as defined in Clause 5.1.4.2 of [6, TS 38.214]. The bitwidth for this field is determined as ┌log₂(n_{ZP}+1)┐ bits, where n_{ZP} is the number of aperiodic ZP CSI-RS resource sets configured by higher layer parameter aperiodicZP-CSI-RS-ResourceSetsToAddModListDCI-1-2.
>: Modulation and coding scheme—5 bits as defined in Clause 5.1.3.1 of [6, TS 38.214]
>: New data indicator—1 bit
>: Redundancy version—0, 1 or 2 bits determined by higher layer parameter numberOfBitsForRV-DCI-1-2
>: HARQ process number—number of bits determined by the following:

### S500 DCI: Gap-Drop-Indication

At S500, UE receives a specific DCI.

Cell may sometimes be used as a collective term that corresponds to frequency layer and component carrier and cell together. cell and frequency layer and component carrier can be used interchangeably.

If tentative drop is included in the DCI:
>: UE considers tentative_drop is not applied for a specific set of serving cells in case that tentative drop is set to a first value (0);
>: UE considers tentative_drop is applied for a specific set of serving cells during a specific time period in case that tentative drop is set to a second value (1).

The specific set of serving cells includes all serving cells in case that the UE is configured with per-UE gaps.

The specific set of serving cells includes all serving cells in case that the UE is configured with MUSIM gaps.

The specific set of serving cells includes serving cells in FR1 in case that the UE is configured with per-FR1 gap and the DCI is received in FR1 serving cell.

The specific set of serving cells includes serving cells in FR2 in case that the UE is configured with per-FR2 gap and the DCI is received in FR2 serving cell.

The specific time period is tentativeDrop window.

The specific time period is [n+m~n+m+k], wherein n is the slot where the DCI is received and m is startingOffset and k is length.

The specific time period includes immediately next Active Time (or onDuration) in case that onDurationDrop is configured.

UE performs gap operations with consideration on received DCI for gap-drop-indication.

### S600 Gap Operation

At S600, UE performs operations related to gaps.

### SSB-Based Measurement

UE performs intra-frequency SSB based measurement without gaps and applies [SA_intra] in case that:
>: [intra-frequency SSB based measurement without gaps] is fulfilled; and
>: tentative_drop is not applied.

UE performs inter-frequency SSB based measurement without gaps and does not apply [SA_inter] in case that:
>: [inter-frequency SSB based measurement without gaps] is fulfilled; and
>: tentative_drop is applied.

UE performs intra-frequency SSB based measurement with gaps and applies [MG_op_1] in case that:
>: [intra-frequency SSB based measurement with gaps] is fulfilled; and
>: tentative_drop is not applied.

UE performs inter-frequency SSB based measurement with gaps and applies [MG_op_2] in case that:
>: [inter-frequency SSB based measurement without gaps] is fulfilled; and
>: tentative_drop is applied.

UE performs MUSIM_op_1 in case that tentative_drop is not applied.

UE performs MUSIM_op_2 in case that tentative_drop is applied.

UE measures the DL PRS resource within the active DL BWP with a numerology same as the numerology of the active DL BWP outside a configured measurement gap.

UE measures a specific DL PRS resource in case that:
>: measurement gap is not configured;
>: measurement gap is configured but deactivated; or
>: measurement gap is configured and activated but dropped.

The specific DL PRS resource is DL PRS resource that is:
>: within the active DL BWP; and
>: with a numerology same as the numerology of the active DL BWP.

### With Gap

UE measures a second specific DL PRS resource during the associated measurement gap in case that:
>: the associated measurement gap is configured and activated and not-dropped.

The second specific DL PRS resource is DL PRS resource that is:
>: not completely within the active DL BWP; or
>: completely within the active DL BWP but with a numerology different from the numerology of the active DL BWP.

UE may request activation/deactivation of preconfigured measurement gap if UE needs activated measurement gap to measure the DL PRS resource. UE transmits a corresponding MAC CE or RRC message to request activation or deactivation.

UE performs [MG_op_1] during activated/not-dropped measurement gap.

UE does not perform [MG_op_2] during activated/dropped measurement gap or during deactivated measurement gap.

activated measurement gap is considered dropped when tentative_drop is applied.

activated measurement gap is considered not-dropped when tentative_drop is not applied.

The UE measures the DL PRS outside the measurement gap if:
>: the DL PRS is inside the active DL BWP;
>: the DL PRS has the same numerology as the active DL BWP;
>: the DL PRS is within the DL PRS processing window (PPW) that is activated and not-dropped.

UE does not measure the DL PRS outside the measurement gap if the expected received timing difference between the DL PRS from the non-serving cell and that from the serving cell is larger than maximum Rx timing difference provided by UE capability even if above conditions are fulfilled.

PPW is considered dropped when tentative_drop is applied.

PPW is considered not-dropped when tentative_drop is not applied.

During a PPW that is activated and not dropped, UE performs measurement/reception of either first set of DL signals (PDCCH+PDSCH+CSI-RS+TRS etc) or DL-PRS.

During a PPW that is dropped, UE performs measurement/reception of first set of DL signals.

### MUSIM Activities

The UE performs [MUSIM_op_1] during the MUSIM gap that is not dropped.

The UE performs [MUSIM_op_2] during the MUSIM gap that is dropped.

MUSIM gap is considered dropped when tentative_drop is applied.

MUSIM gap is considered not-dropped when tentative_drop is not applied.

### Measurement Gap

>: for each measId included in the measIdList within VarMeasConfig:
>>: if the report Type for the associated reportConfig is periodical, eventTriggered;
>>>: if a measurement gap configuration is setup/activated/not-dropped, or
>>>: if the UE does not require measurement gaps to perform the concerned measurements:
>>>>: if s-MeasureConfig is not configured, or
>>>>: if s-MeasureConfig is set to ssb-RSRP and the NR SpCell RSRP based on SS/PBCH block, after layer 3 filtering, is lower than ssb-RSRP, or
>>>>: if s-MeasureConfig is set to csi-RSRP and the NR SpCell RSRP based on CSI-RS, after layer 3 filtering, is lower than csi-RSRP:
>>>>>: if the measObject is associated to NR and the rsType is set to csi-rs:
>>>>>>: if reportQuantityRS-Indexes and maxNrofRS-IndexesToReport for the associated reportConfig are configured:
>>>>>>>: derive layer 3 filtered beam measurements only based on CSI-RS for each measurement quantity indicated in reportQuantityRS-Indexes, as described in 5.5.3.3a;
>>>>>>: derive cell measurement results based on CSI-RS for the trigger quantity and each measurement quantity indicated in reportQuantityCell using parameters from the associated measObject, as described in 5.5.3.3;
>>>>>: if the measObject is associated to NR and the rsType is set to ssb:
>>>>>>: perform measurement on SSBs associated with the measObject;
>>>>>>: if reportQuantityRS-Indexes and maxNrofRS-IndexesToReport for the associated reportConfig are configured:
>>>>>>>: derive layer 3 beam measurements only based on SS/PBCH block for each measurement quantity indicated in reportQuantityRS-Indexes, as described in 5.5.3.3a;
>>>>>>: derive cell measurement results based on SS/PBCH block for the trigger quantity and each measurement quantity indicated in reportQuantityCell using parameters from the associated measObject, as described in 5.5.3.3;
>>>>>: if the measObject is associated to E-UTRA:
>>>>>>: perform the corresponding measurements associated to neighbouring cells on the frequencies indicated in the concerned measObject, as described in 5.5.3.2;
>>>>>: if the measObject is associated to UTRA-FDD:
>>>>>>: perform the corresponding measurements associated to neighbouring cells on the frequencies indicated in the concerned measObject, as described in 5.5.3.2;
>>>>>: if the measObject is associated to L2 U2N Relay UE:
>>>>>>: perform the corresponding measurements associated to candidate Relay UEs on the frequencies indicated in the concerned measObject, as described in 5.5.3.4;
>>>>: if the measRSSI-ReportConfig is configured in the associated reportConfig:
>>>>>: perform the RSSI and channel occupancy measurements on the frequency configured by rmtc-Frequency in the associated measObject;

### RRM Measurement

To perform measurement on measObject without measurement gap:
>: if measObject concerns serving-frequency (or intra-frequency measurement); and
>: if UE is allowed to perform intra-frequency SSB based measurement without measurement gap according to [intra-frequency SSB based measurement without gaps],
>>: UE performs intra-frequency measurement without gap. [SA_intra] is applied.
>: if measObject concerns non-serving-frequency (or inter-frequency measurement); and
>: if UE is allowed to perform inter-frequency SSB based measurements without measurement gaps according to [inter-frequency SSB based measurement without gaps],
>>: UE performs inter-frequency measurement without gap. [SA_inter] is applied.

To perform measurement on measObject with measurement gap:
>: if measObject concerns serving-frequency (or intra-frequency measurement); and
>: if the UE requires measurement gaps to perform the concerned measurements according to [intra-frequency SSB based measurement with gaps]; and
>: a measurement gap associated with measObject is configured and activated and not dropped,
>>: UE performs intra-frequency measurement with measurement gap.
>: if measObject concerns non-serving-frequency (or inter-frequency measurement),
>: if the UE requires measurement gaps to perform the concerned measurements according to [inter-frequency SSB based measurement with gaps]; and
>: a measurement gap associated with measObject is configured and activated and not dropped,
>>: UE performs inter-frequency measurement with measurement gap.

UE performs measurement with measurement gap during measurement gap that is activated and not dropped.

UE performs measurement without measurement gap according to corresponding SMTC.

That [SA_intra/_inter] is applied means that:
>: scheduling restrictions indicated in [SA_intra/_inter] is applied; and
>: PUCCH/PUSCH/SRS transmissions on a first set of symbols is not performed; and
>: PDCCH/PDSCH/TRS/CSI-RS for CQI reception on the first set of symbols is not performed.

That [SA_intra/_inter] is not applied means that:
>: scheduling restrictions indicated in [SA_intra/_inter] is not applied; and
>: PUCCH/PUSCH/SRS transmissions on a first set of symbols is performed; and
>: PDCCH/PDSCH/TRS/CSI-RS for CQI reception on the first set of symbols is performed.

In case of intra-frequency measurement on FR1, the first set of symbols includes:
>: SSB symbols to be measured; and
>: 1 data symbol before each consecutive SSB symbols to be measured within SMTC window duration; and
>: 1 data symbol after each consecutive SSB symbols to be measured within SMTC window duration.

In case of intra-frequency measurement on FR2, the first set of symbols includes:
>: SSB symbols to be measured; and
>: K data symbols before each consecutive SSB symbols to be measured within SMTC window duration; and
>: K data symbol after each consecutive SSB symbols to be measured within SMTC window duration.

In case of inter-frequency measurements associated with a set of measObjects, the first set of symbols includes, while SSB symbols to be measured is union of SSB symbols to be measured that are associated with the set of measObjects:
>: serving cell symbols fully or partially overlap with SSB symbols to be measured;
>: n serving cell symbols before each consecutive SSB symbols to be measured within SMT window duration; and
>: n serving cell symbols after each consecutive SSB symbols to be measured within SMTC window duration.

### [Positioning Measurement Gap Activation/Deactivation Command]

If the UE is configured with pre-configured measurement gaps, the network may send DL MAC CE for Positioning Measurement Gap Activation/Deactivation Command to the UE. For the activated measurement gap, the UE shall follow the specified UE behaviour in clause 5.14.

Upon the reception of the MAC CE for Positioning Measurement Gap Activation/Deactivation Command, the MAC entity shall:
>: if the Positioning Measurement Gap Activation/Deactivation Command MAC CE indicates the deactivation of a pre-configured positioning measurement gap:
>>: deactivate the positioning measurement gap.
>: else if the Positioning Measurement Gap Activation/Deactivation Command MAC CE indicates the activation of a pre-configured measurement gap:
>>: activate the positioning measurement gap and perform the procedure specified in clause 5.14 of TS 38.321.

### [Positioning Measurement Gap Activation/Deactivation Request MAC CE]

The Positioning Measurement Gap Activation/deactivation request MAC CE is identified by MAC subheader with eLCID.

It has a fixed 8-bit size defined as follows:
Positioning MG ID: This field indicates the identifier for the pre-configured positioning measurement gap. The length of the field is 4 bits;
A/D: This field indicates the activation or deactivation of the Positioning Measurement Gap. The field is set to 1 to indicate activation, otherwise it indicates deactivation. The length of the field is 1 bit;
R: Reserved bit, set to 0.

### [Positioning Measurement Gap Activation/Deactivation Command MAC CE]

The Positioning Measurement Gap Activation/Deactivation Command MAC CE is identified by MAC subheader with eLCID as specified in Table 6.2.1-1b.

It has a fixed 8-bit size defined as follows:
Positioning MG ID: This field indicates the identifier for the preconfigured positioning measurement gap. The length of the field is 4 bits;
A/D: This field indicates the activation or deactivation of the Positioning Measurement Gap. The field is set to 1 to indicate activation, otherwise it indicates deactivation. The length of the field is 1 bit;
R: Reserved bit, set to 0.

### PRS Measurement

### [PPW Activation/Deactivation Command]

If the UE is configured with pre-configured PPW, the network may send DL MAC CE for PPW Activation/Deactivation Command to the UE as in clause 6.1.3.42. For the activated PPW, the UE shall follow the specified UE behaviour in clause 5.24.

Upon activation of DL BWP, the PPW(s) configured for that BWP are considered deactivated. Upon reconfiguration of PPW(s) of the active DL BWP, all the PPW(s) for that BWP are considered deactivated.

Upon the reception of the MAC CE for PPW Activation/Deactivation Command, the MAC entity shall:
>: if the DL MAC CE for PPW Activation/Deactivation Command indicates the deactivation of a pre-configured PPW:
>>: deactivate the PPW.
>: else if the DL MAC CE for PPW Activation/Deactivation Command indicates the activation of a pre-configured PPW:
>>: activate the PPW according to the procedure specified in clause 5.24.

### [Handling of PRS Processing Window]

When PPW is activated and PRS has higher priority than DL channel and signals, for the affected symbols within the PPW according to clause 5.1.6.5 in TS 38.214 [7], the MAC entity shall:
>: if the ra-ResponseWindow or the ra-ContentionResolutionTimer or the msgB-ResponseWindow is running:
>>: monitor the PDCCH.
>: else:
>>: not receive DL-SCH;
>>: not receive PDCCH.

### [PPW Activation/Deactivation Command MAC CE]

The PPW Activation/Deactivation Command MAC CE is identified by MAC subheader with eLCID as specified in Table 6.2.1-1b.

It has variable size defined as follows:
numEntry: This field indicates the number of entries N−1 in the MAC CE. 00 indicates that N equals to 2; 01 indicates that N equals to 3 and so on. The length of the field is 2 bits; Entry is triplet of serving cell ID, PPW ID and A/D.
Serving Cell ID: This field indicates the identity of the Serving Cell for which the MAC CE applies. The length of the field is 5 bits;
PPW ID: This field indicates the index of the PPW configured on active DL BWP of the Serving Cell identified by the above Serving Cell ID. Index 0 corresponds to the first entry within the list of the PPW configuration by the increasing order of dl-PPW-ID in TS 38.331 in this BWP, index 1 corresponds to the second entry in the list and so on. The length of the field is 2 bits;
A/D: This field indicates the activation or deactivation of the PPW. The field is set to 1 to indicate activation, otherwise it indicates deactivation. The length of the field is 1 bit;

The UE is expected to measure the DL PRS resource outside the active DL BWP or with a numerology different from the numerology of the active DL BWP if the measurement is made during a configured (activated/not-dropped) measurement gap. When the UE is expected to measure the DL PRS resource, the UE may request a measurement gap via higher layer parameter NR-PRS-MeasurementInfoList [TS 38.331] or as specified in clause 6.1.3.40 of [TS 38.321]. The UE may be preconfigured with one or more measurement gaps each associated with a measPosPreConfigGapId. When the UE requests activation or deactivation of a measurement gap as specified in clause 6.1.3.40 of [TS 38.321] it can request one of the preconfigured measurement gaps by referring to the measPosPreConfigGapId. The UE may have one of the preconfigured measurement gap(s) activated or deactivated as specified in clause 6.1.3.41 of [TS 38.321].

The UE assumes that the DL PRS from the serving cell is not mapped to any symbol that contains SS/PBCH block from the serving cell. If the time frequency location of the SS/PBCH block transmissions from non-serving cells are provided to the UE then the UE also assumes that the DL PRS from a non-serving cell is not mapped to any symbol that contains the SS/PBCH block of the same non-serving cell.

### PRS Processing Window

The UE is expected to measure the DL PRS outside the measurement gap, subject to UE capability, if the DL PRS is inside the active DL BWP and has the same numerology as the active DL BWP and is within the DL PRS processing window indicated by higher layer parameter DL-PPW-PreConfig. The UE is not expected to measure the DL PRS outside the measurement gap if the expected received timing difference between the DL PRS from the non-serving cell and that from the serving cell, determined by the higher layer parameters nr-DL-PRS-ExpectedRSTD and nr-DL-PRS-ExpectedRSTD-Uncertainty, is larger than maximum Rx timing difference provided by UE capability. For receiving the DL PRS outside the measurement gap and within the DL PRS processing window, the priority between DL PRS and SSB is defined in [TS 38.133] and the UE determines the DL PRS priority as indicated by higher layer parameter priority subject to UE capability or as implied by UE capability, except for SSB:
with value ‘st1’ where the DL PRS is higher priority than all the DL signals and channels, or
with value ‘st2’ where the DL PRS is lower priority than PDCCH and the PDSCH scheduled by DCI formats 1_1, 1_2, 1_3 or 4_2 with the priority indicator field in the corresponding DCI format set to 1, and is higher priority than other DL signals and channels, or
with value ‘st3’ where the DL PRS is lower priority than all the DL signals and channels.

Inside one DL-PPW-PreConfig the UE is only expected to measure a single DL PRS positioning frequency layer.

When the UE is expected to measure the DL PRS outside the measurement gap in a configured DL PRS processing window with type1A and if the DL PRS is determined to be higher priority than the DL signals and channels inside the DL PRS processing window, those DL signals and channels are not expected to be measured by the UE.

When the UE is expected to measure the DL PRS outside the measurement gap in a configured DL PRS processing window with type1B and if the DL PRS is determined to be higher priority than the DL signals and channels inside the DL PRS processing window, those DL signals and channels in the same band as the DL PRS are not expected to be measured by the UE.

When the UE is expected to measure the DL PRS outside the measurement gap in a configured DL PRS processing window with type2 if the DL PRS is determined to be higher priority than the DL signals and channels inside the DL PRS processing window, those DL signals and channels from the impacted serving cells are not expected to be measured by the UE on the overlapped symbols with the DL PRS, where impacted serving cells refer to the serving cell on which the DL-PPW-PreConfig is configured for a frequency range 1 band, and all the serving cells in the same band as the DL PRS for a frequency range 2 band.

When the UE is expected to measure the DL PRS outside the measurement gap in a configured DL PRS processing window with type1B or type2, and if the DL PRS is determined to be higher priority than the DL signals and channels inside the DL PRS processing window, the UE behavior is described in [TS 38.133] for inter-band case for frequency range 2 for the DL signals/channels from a different frequency range 2 band than the frequency range 2 band of the DL PRS.

When the UE has an activated/not-dropped DL PRS processing window with type1A or type1B and the UE determines the presence of other DL signals and channels, except SSB, of higher priority than the DL PRS in the DL PRS processing window no later than N2 symbols, defined in clause 6.4 for the subcarrier spacing u of the DL PRS, before the first symbol of the DL PRS processing window, the UE is expected to receive the other DL signals and channels and drop all PRS within the DL PRS processing window.

When the UE has an activated/not-dropped DL PRS processing window with type2 and the UE determines the presence of other DL signals and channels, except SSB, of higher priority than the DL PRS on a symbol configured with the DL PRS no later than N2 symbols, defined in clause 6.4 for the subcarrier spacing u of the DL PRS, before the DL PRS symbol, the UE is expected to receive the other DL signals and channels and drop the DL PRS symbol.

When the UE has an activated DL PRS processing window with type1A or type1B and the UE determines the presence of other DL signals and channels, except SSB, of higher priority than the DL PRS in the DL PRS processing window later than N2 symbols, defined in clause 6.4 for the subcarrier spacing u of the DL PRS, before the first symbol of the DL PRS processing window, the UE is not required to receive the other DL signals and channels and may receive the DL PRS and consider the DL PRS as higher priority in the DL PRS processing window. When the UE has an activated DL PRS processing window with type2 and the UE determines the presence of other DL signals and channels, except SSB, of higher priority than the DL PRS on a symbol configured with the DL PRS later than N2 symbols, defined in clause 6.4 for the subcarrier spacing u of the DL PRS, before the DL PRS symbols, the UE is not required to receive the other DL signals and channels and may receive the DL PRS symbol and consider the DL PRS as higher priority in that symbol.

If the UE is configured with pre-configured PPW, the network may send DL MAC CE for PPW Activation/Deactivation Command to the UE. For the activated PPW, the UE shall follow the specified UE behaviour.

Upon activation of DL BWP, the PPW(s) configured for that BWP are considered deactivated. Upon reconfiguration of PPW(s) of the active DL BWP, all the PPW(s) for that BWP are considered deactivated.

Upon the reception of the MAC CE for PPW Activation/Deactivation Command, the MAC entity shall:
>: if the DL MAC CE for PPW Activation/Deactivation Command indicates the deactivation of a pre-configured PPW:
>>: deactivate the PPW.
>: else if the DL MAC CE for PPW Activation/Deactivation Command indicates the activation of a pre-configured PPW:
>>: activate the PPW according to the procedure specified in clause 5.24 of TS 38.321.

When PPW is activated/not-dropped and PRS has higher priority than DL channel and signals, for the affected symbols within the PPW,
the MAC entity shall:
>: if the ra-ResponseWindow or the ra-ContentionResolutionTimer or the msgB-ResponseWindow is running:
>>: monitor the PDCCH.
>: else:
>>: not receive DL-SCH;
>>: not receive PDCCH.

### MUSIM Gap

The UE is not required to perform cell identification and measurement, paging monitoring, SIB acquisition, and/or on-demand SI request of the target cell in the target network that is outside the MUSIM gaps.

The UE is not required to conduct reception or transmission from or to the [source] network during MUSIM gaps that are not dropped due to collisions.

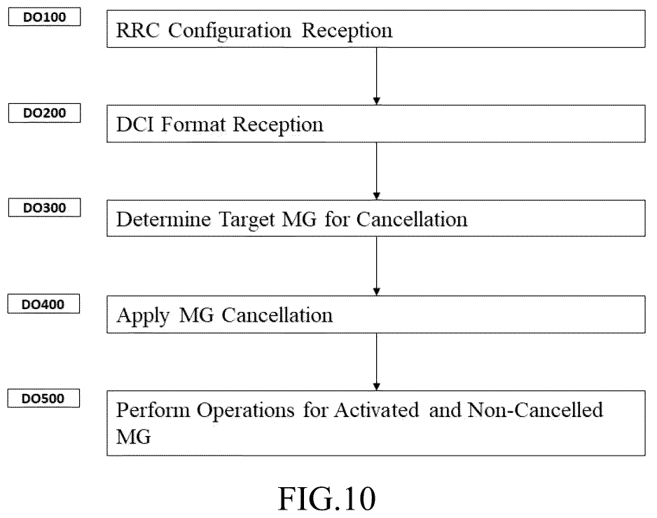

FIG. 10 illustrates UE operations.

### At DO100: RRC Configuration Reception

The UE receives an RRC message from the base station containing:
Information indicating whether MG cancellation related information is included for a specific set of DCI formats
MG configuration information that configures per-FR1 gap and per-FR2 gap

### At DO200: DCI Format Reception

The UE receives a specific DCI format (from the specific set of DCI formats including at least two DCI formats for uplink scheduling and two DCI formats for downlink scheduling)

The MG cancellation related information in the received DCI format is set to a specific value (indicating MG cancellation is triggered)

### At DO300: Determine Target MG for Cancellation

The UE determines which MG to cancel based on the FR of the serving cell associated with the received DCI format:
If the serving cell is on FR1→per-FR1 gap is selected
If the serving cell is on FR2→per-FR2 gap is selected

The target MG is at least one MG occurring after a certain time point (determined by DCI reception time+predefined time offset)

### At DO400: Apply MG Cancellation

The UE cancels the determined specific MG

Note: MG cancellation is not applied to positioning measurement gaps or pre-configured measurement gaps

MG cancellation is applied to a specific measurement gap among concurrent measurement gaps

### At DO5005: Perform Operations for Activated and Non-Cancelled MG

For any MG that is activated and has not been cancelled, the UE performs specific operations:
Does not perform transmission of HARQ feedback, SR, and CSI
Does not report SRS
Transmits on UL-SCH only for Msg3
Monitors PDCCH only when a random access response is expected

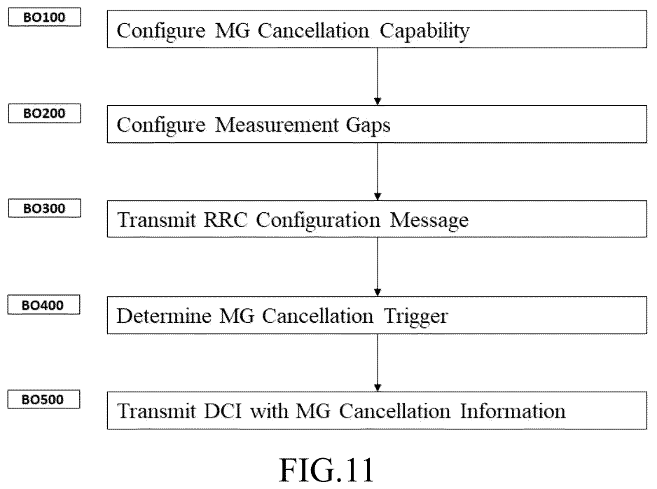

FIG. 11 illustrates base station operations.

### At BO100: Configure MG Cancellation Capability

The base station determines whether to enable MG cancellation functionality for the UE

The base station prepares configuration information indicating whether MG cancellation related information is included for a specific set of DCI formats

### At BO200: Configure Measurement Gaps

The base station configures MG configuration information for the UE

The configuration includes per-FR1 gap and per-FR2 gap settings

The base station excludes positioning measurement gaps and pre-configured measurement gaps from being subject to MG cancellation

### At BO300: Transmit RRC Configuration Message

The base station transmits an RRC message to the UE containing:
Information indicating whether MG cancellation related information is included for a specific set of DCI formats
MG configuration information

### At BO400: Determine MG Cancellation Trigger

The base station determines when to trigger MG cancellation based on scheduling decisions

The base station selects a specific DCI format from the specific set of DCI formats (at least two DCI formats for uplink scheduling and two DCI formats for downlink scheduling)

The base station sets the MG cancellation related information to a specific value in the selected DCI format

At BO500: Transmit DCI with MG Cancellation Information

The base station transmits the specific DCI format to the UE via a serving cell

The transmitted DCI triggers cancellation of:
Per-FR1 gap if the serving cell is on FR1, or
Per-FR2 gap if the serving cell is on FR2

The cancellation applies to MG(s) occurring after a certain time point (DCI transmission time+predefined time offset)

Referring to the diagram, the terminal includes a controller (6A01), a storage unit (6A02), a transceiver (6A03), a main processor (6A04) and I/O unit (6A05).

The controller (6A01) controls the overall operations of the terminal in terms of mobile communication. For example, the controller (6A01) receives/transmits signals through the transceiver (6A03). In addition, the controller (6A01) records and reads data in the storage unit (6A02). To this end, the controller (6A01) includes at least one processor. For example, the controller (6A01) may include a communication processor (CP) that performs control for communication and an application processor (AP) that controls the upper layer, such as an application program. The controller controls storage unit and transceiver such that UE operations illustrated in this disclosure are performed.

The storage unit (6A02) stores data for operation of the terminal, such as a basic program, an application program, and configuration information. The storage unit (6A02) provides stored data at a request of the controller (6A01).

The transceiver (6A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (6A04) controls the overall operations other than mobile operation. The main processor (6A04) process user input received from I/O unit (6A05), stores data in the storage unit (6A02), controls the controller (6A01) for required mobile communication operations and forward user data to I/O unit (6A05).

I/O unit (6A05) consists of equipment for inputting user data and for outputting user data such as a microphone and a screen. I/O unit (6A05) performs inputting and outputting user data based on the main processor's instruction.

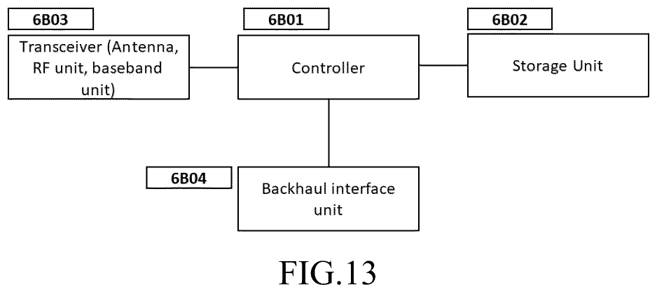

FIG. 13 is a block diagram illustrating the configuration of a base station according to the disclosure.

As illustrated in the diagram, the base station includes a controller (6B01), a storage unit (6B02), a transceiver (6B03) and a backhaul interface unit (6B04).

The controller (6B01) controls the overall operations of the main base station. For example, the controller (6B01) receives/transmits signals through the transceiver (6B03), or through the backhaul interface unit (6B04). In addition, the controller (6B01) records and reads data in the storage unit (6B02). To this end, the controller (6B01) may include at least one processor. The controller controls transceiver, storage unit and backhaul interface such that base station operation illustrated in FIG. 3 are performed.

The storage unit (6B02) stores data for operation of the main base station, such as a basic program, an application program, and configuration information. Particularly, the storage unit (6B02) may store information regarding a bearer allocated to an accessed UE, a measurement result reported from the accessed UE, and the like. In addition, the storage unit (6B02) may store information serving as a criterion to determine whether to provide the terminal with multi-connection or to discontinue the same. In addition, the storage unit (6B02) provides stored data at a request of the controller (6B01).

The transceiver (6B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (6B04) provides an interface for communicating with other nodes inside the network. The backhaul interface unit (6B04) converts a bit string transmitted from the base station to another node, for example, another base station or a core network, into a physical signal, and converts a physical signal received from the other node into a bit string.

What is claimed is:

1. A method performed by a user equipment (UE) in a wireless communication system, the method comprising:
receiving a Radio Resource Control (RRC) message from a base station, wherein the RRC message comprises:
information indicating whether measurement gap (MG) cancellation related information is included for a specific set of Downlink Control Information (DCI) formats; and
MG configuration information for configuring MG;
receiving a specific DCI format, wherein the MG cancellation related information is set to a value indicating MG cancellation;
determining a specific MG based on a Frequency Range (FR) to which a serving cell associated with the specific DCI format belongs; and
cancelling the determined specific MG.

2. The method of claim 1, wherein the specific set of DCI formats includes at least two DCI formats for uplink scheduling and at least two DCI formats for downlink scheduling.

3. The method of claim 1, wherein:
the MG cancellation is not applied to a positioning measurement gap and a pre-configured measurement gap; and
the MG cancellation is applied to a configured measurement gap among concurrent measurement gaps.

4. The method of claim 1, wherein a per-FR1 MG and a per-FR2 MG are configured according to the MG configuration information.

5. The method of claim 4, wherein:
the per-FR1 MG is cancelled based on the specific DCI format in case that the serving cell associated with the specific DCI format is on FR1; and
the per-FR2 MG is cancelled based on the specific DCI format in case that the serving cell associated with the specific DCI format is on FR2.

6. The method of claim 1, wherein:
the specific MG is at least one MG occurring after a specific time point, and the specific time point is determined based on:
a time at which the specific DCI format is received; and
a predefined time offset.

7. The method of claim 1, further comprising:
performing a specific operation for an MG in case that the MG is activated and has not been cancelled by the specific DCI format.

8. The method of claim 7, wherein the specific operation comprises:
refraining from:
transmission of Hybrid Automatic Repeat Request (HARQ) feedback, Scheduling Request (SR), and Channel State Information (CSI), and
reporting of a Sounding Reference Signal (SRS); and
performing:
transmission on an Uplink Shared Channel (UL-SCH) for Msg3, and
monitoring of a Physical Downlink Control Channel (PDCCH) in case that a random access response is expected.

9. A terminal in a wireless communication system, the terminal comprising:
a transceiver configured to transmit and receive signals, and
a controller configured to control the transceiver to:
receive a Radio Resource Control (RRC) message from a base station, wherein the RRC message comprises:
information indicating whether measurement gap (MG) cancellation related information is included for a specific set of Downlink Control Information (DCI) formats; and
MG configuration information for configuring MG;
receive a specific DCI format, wherein the MG cancellation related information is set to a value indicating MG cancellation;
determine a specific MG based on a Frequency Range (FR) to which a serving cell associated with the specific DCI format belongs; and
cancel the determined specific MG.
